(19) United States
(12) Patent Application Publication
(10) Pub. No.: US 2023/0257528 A1
(43) Pub. Date: Aug. 17, 2023

(54) SURFACE TREATING COMPOSITION

(71) Applicants: MOMENTIVE PERFORMANCE MATERIALS INC., Waterford, NY (US); DAIKIN INDUSTRIES, LTD., Osaka (JP)

(72) Inventors: Hisashi MITSUHASHI, Osaka (JP); Takashi NOMURA, Osaka (JP); Motoshi MATSUI, Osaka (JP); Noriaki FUKUDA, Osaka (JP); Raghavendra HEBBAR, Bangalore (IN); Hao SHEN, Verona, NJ (US); Banpreet KAUR, New Delhi (IN); Karthikeyan SIVASUBRAMANIAN, Bangalore (IN); Shreedhar BHAT, Bangalore (IN)

(21) Appl. No.: 18/011,550

(22) PCT Filed: Jul. 1, 2021
(86) PCT No.: PCT/US2021/040095

§ 371 Date: Dec. 20, 2022

Related U.S. Application Data
(60) Provisional application No. 63/047,495, filed on Jul. 2, 2020.

(51) Int. Cl. C08G 77/46; C09D 171/00

(52) U.S. Cl. CPC C08G 77/46; C09D 171/00

(57) ABSTRACT

A surface treating composition is shown and described herein. A surface treating composition comprises (i) a hybrid siloxane oligomer comprises organosilicon units wherein the oligomer comprises organosilicon units with fluoro-functional groups, and organosilicon units with other reactive functionality, and (ii) a perfluoro(poly)ether group containing silane compound. The surface treating composition can be employed to provide a hydrophobic and/or oleophobic surface coating on a surface of a substrate, which may impart other beneficial properties to the article.

### CROSS-REFERENCE TO RELATED APPLICATIONS

This application claims priority to and the benefit of U.S. Provisional Patent Application No. 63/047,495 titled “SURFACE TREATING COMPOSITION” filed on Jul. 2, 2020, the disclosure of which is incorporated herein by reference in its entirety.

### FIELD OF INVENTION

The present invention relates to a composition for treating a surface. In particular, the present invention relates to composition for treating a surface comprising (i) a hybrid siloxane oligomer comprising fluoro-functional groups and an organo functional group, and (ii) a pefluoro(poly)ether group containing silane.

### BACKGROUND

Coatings that exhibit hydrophobic and/or oleophobic properties are of interest to protect surfaces exposed to various conditions including environmental conditions. Coatings that exhibit hydrophobic or oleophobic properties exhibit relatively large water contact angle or oil contact angle, respectively, to impart roll-off properties, weather resistance, and durability to a surface of an article coated with such materials.

Generally, a surface is considered hydrophobic or oleophobic if the water contact angle or oil contact angle, respectively, is greater than 90°. An example of a hydrophobic surface is a polytetrafluoroethylene (Teflon™) surface. Water contact angles on a polytetrafluoroethylene surface can reach about 115°. Surfaces with a water contact angle greater or an oil contact angle greater than 130° are considered “superhydrophobic” or “superoleophobic,” respectively. Superhydrophobic or superoleophobic coatings display a “self cleaning” property, in which dirt or spores, bacteria, or other microorganisms that come into contact with the surface are unable to adhere to the coating and are readily washed away with water. Further, the extreme water repellency of such coatings gives the surface anti-fouling, anti-icing, and/or anti-corrosion properties.

Roll-off angle is the smallest possible angle of inclination of the surface under test, with respect to the horizontal, which is sufficient to cause the liquid drop to move away from this surface. Roll-off angle and hysteresis of a water droplet indicates the stability of the droplet on the surface; the lower the value for these two parameters, the less the stability of the droplet and therefore, the easier the roll-off of the droplet from the surface.

Typically superhydrophobic and/or superoleophobic surfaces are created by changing the surface chemistry and/or by increasing the surface roughness via surface texturing so as to increase the true or effective surface area, or a combination of both methods. Surface texturing may be cumbersome and expensive. Further, it can be difficult to achieve for large and complex articles. Superhydrophobic surfaces have also been produced by multi-layered techniques involving the formation of a first layer of surface roughness followed by chemical treatment with a fluorinated surface modifier. A superhydrophobic and/or superoleophobic surface can be created by chemical methods by coating the surface of an article with a superhydrophobic and/or superoleophobic coating, layer, or a film. Coating the surface with a superhydrophobic/superoleophobic coating is a very efficient means of converting any surface into a superhydrophobic/superoleophobic surface. However, most of such superhydrophobic/superoleophobic coatings suffer from poor adhesion to the surface, lack mechanical robustness, and are prone to scratches.

### SUMMARY

The following presents a summary of this disclosure to provide a basic understanding of some aspects. This summary is intended to neither identify key or critical elements nor define any limitations of embodiments or claims. Furthermore, this summary may provide a simplified overview of some aspects that may be described in greater detail in other portions of this disclosure.

Provided is a surface treating composition comprising (i) a hybrid siloxane oligomer comprising siloxane units functionalized with a fluoro-functional group and siloxane units functionalized with a organofunctional group, and (ii) pefluoro(poly)ether containing silane. The surface treating compositions can provide a coating that can exhibit hydrophobic and/or oleophobic properties. The coatings can be adhered to a variety of materials such that the coatings can be useful to protect a variety of articles and substrates.

In another aspect, provided is an article comprising a base material and a surface treating layer disposed on a surface of the base material, wherein the surface treating layer is formed from the composition.

In still another aspect, provided is a method of forming an article comprising applying the composition to a surface of a base material to form a coating layer.

In one aspect, provided is a composition, which comprises

(i) a compound, and/or the compound's partially hydrolyzed condensate, represented by the formula (1):

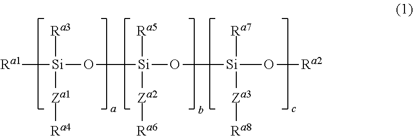

where R^{a1}, R^{a3}, R^{a5}, and R^{a7} are each independently selected from an alkoxy, an alkoxycarbonyl, a halide, an alkyl, an aralkyl, or an aromatic group, with the proviso that at least one of R^{a1}, R^{a3}, R^{a5}, and/or R^{a7} is an alkoxy, an alkoxycarbonyl, or a halide group;
R^{a2} is selected from hydrogen, an alkyl, an aralkyl, or an aromatic group;
R^{a4} is represented by the formula CzHyFx where z is 1-20 and x+y is 2z+1 where x is 1 or greater.
R^{a6} and R^{as} are each independently selected from an alkoxy, an alkoxycarbonyl, a halide, an alkyl, an aralkyl, an aromatic group, an epoxy, an amine;
Z^{a1}, Z^{a2}, and Z^{a3} are each independently selected from an organic linking group having 1-20 carbon atoms optionally containing heteroatoms, with the proviso that when R^{a6} or R^{a8} is an alkoxy, an alkoxycarbonyl, or a halide, then Z^{a2} or Z^{a3}, respectively, cannot be O, N, or S; a, b, and c are each independently 0 to about 100, a+b+c is greater than 0, a is greater than 0, and b+c is greater than 0; and

(ii) a pefluoro(poly)ether group containing silane of Formula (2) and/or Formula (3):

[A]_{b1}Q²[B]_{b2} Formula (2)

[B]_{b2}Q²[A]Q²[B]_{b2} Formula (3)

where, Q² is a linking group having a valency of (b1+b2),
A is a group represented by R^{f3}—O—R^{f}— or —R^{f3}—O—R^{f2}—, where R^{f} is a poly(oxyfluoroalkylene) chain, and R^{f3} is a perfluoroalkyl group or perfluoroalkylene group,
B is a monovalent group having one —R¹²—(SiR²ᵣ—X²₃₋ᵣ), where R¹² is a organic group preferably hydrocarbon group having 2 to 10 carbon atoms that optionally has an ether oxygen atom between the carbon-carbon atoms or at an end opposite to a side bonded with Si or optionally has —NH— between the carbon-carbon atoms, R² are each independently a hydrogen atom or a monovalent hydrocarbon group having 1 to 6 carbon atoms, the hydrocarbon group optionally containing a substituent, X² are each independently a hydroxyl group or a hydrolyzable group, and r is an integer of 0 to 2, and including no fluorine atom,
Q² and B include no cyclic siloxane structure,
b1 is an integer of 1 to 3,
b2 is an integer of 1 to 9, and
in a case where b1 is 2 or more, b1 pieces of A may be identical or different, and b2 pieces of B may be identical or different.

In one embodiment, R^{f2} in Formula (2) and/or Formula (3) is a group represented by —(CₐF₂ₐO)ₙ—, where a is an integer of 1 to 6, n is an integer of 2 or more, and the —CₐF₂ₐO— units may be identical or different.

In one embodiment, R^{f2} in Formula (2) and/or Formula (3) is a group represented by a group —(CF₂CF₂CF₂CF₂CF₂CF₂O)ₙ₁—(CF₂CF₂CF₂CF₂CF₂O)ₙ₂—(CF₂CF₂CF₂CF₂O)ₙ₃—(CF₂CF₂CF₂O)ₙ₄—(CF(CF₃)CF₂O)ₙ₅—(CF₂CF₂O)ₙ₆—(CF₂O)ₙ₇—, where n1, n2, n3, n4, n5, n6, and n7 are each independently an integer of 0 or more, the sum of n1, n2, n3, n4, n5, n6, and n7 is 2 or more, and the repeating units may exist in block, alternately, or randomly.

In one embodiment, R^{f} in Formula (1) is a group represented by a group —C₆F₁₃.

In one embodiment, the number average molecular weight of said compound by the formula (1) and the compound's partially hydrolyzed condensate are preferably at least 300, more preferably at least 500, more preferably at least 1000.

In one embodiment, the number average molecular weight of said compound by the formula (1) and the compound's partially hydrolyzed condensate are preferably at most 10000, more preferably at most 5000, more preferably at most 3000.

In one embodiment, the content of said compound represented by the formula (1) and the compound's partially hydrolyzed condensate are 10 mass % or less, preferably 5 mass % or less of the total weight of the composition.

In one embodiment, the content of said compound represented by the formula (1) and the compound's partially hydrolyzed condensate are 0.01 mass % or more, preferably 0.1 mass % or more of the total composition.

In one embodiment, formula 2 is at least the compound selected from the group consisting of (A1), (A2), (B1), (B2), (C1), (C2), (D1) and (D2):

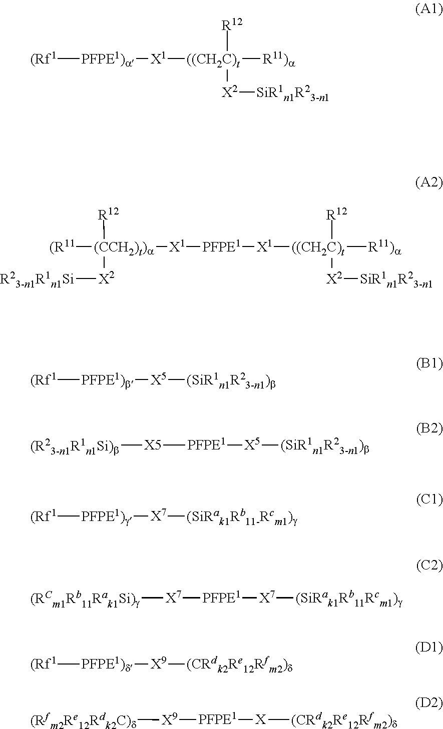

wherein:
PFPE is each independently at each occurrence a group of the formula:

—(OC4F8)a-(OC3F6)b-(OC2F4)c-(OCF2)d-

wherein a, b, c and d are each independently an integer of 0-200 with (a+b+c+d)≥1, and the order of the repeating units in parentheses with the subscripts a-d is not limited;
Rf is each independently at each occurrence C1-16-alkyl optionally substituted by F;
R¹ is each independently at each occurrence OH or a hydrolyzable group;
R² is each independently at each occurrence H or C1-22-alkyl;
R¹¹ is each independently at each occurrence H or halogen;
R¹² is each independently at each occurrence H or lower alkyl;
n1 is, independently per a unit (—SiR¹ₙ1R²₃₋ₙ₁), an integer of 0-3;
at least one n1 is an integer of 1-3 in the formulae (A1), (A2), (B1) and (B2);
X¹ is each independently a single bond or a 2-10 valent organic group;
X² is each independently at each occurrence a single bond or a divalent organic group;
t is each independently at each occurrence an integer of 1-10;
α is each independently an integer of 1-9;
α′ is each independently an integer of 1-9;
X⁵ is each independently a single bond or a 2-10 valent organic group;
β is each independently an integer of 1-9;
β′ is each independently an integer of 1-9;
X⁷ is each independently a single bond or a 2-10 valent organic group;
γ is each independently an integer of 1-9;
γ′ is each independently an integer of 1-9;
R^{a} is each independently at each occurrence —Z¹—SiR⁷¹ₚ₁R⁷²_{q1}R⁷³ᵣ₁;
Z¹ is each independently at each occurrence O or a divalent organic group;
R⁷¹ is each independently at each occurrence R^{a′} having the same definition as R^{a};
R⁷² is each independently at each occurrence OH or a hydrolyzable group;
R⁷³ is each independently at each occurrence H or lower alkyl;
p1 is each independently at each occurrence an integer of 0-3;
q1 is each independently at each occurrence an integer of 0-3;
r1 is each independently at each occurrence an integer of 0-3;
at least one q1 is an integer of 1-3 in the formula (C1) and (C2);
and in R^{a} the number of Si atoms which are straightly linked via the Z¹ group is ≤5;
R^{b} is each independently at each occurrence OH or a hydrolyzable group;
R^{c} is each independently at each occurrence H or lower alkyl;
k1 is each independently at each occurrence an integer of 1-3;
l1 is each independently at each occurrence an integer of 0-2;
is each independently at each occurrence an integer of 0-2;
and (k1+l1+m1)=3 in each unit in parentheses with the subscript γ;
X⁹ is each independently a single bond or a 2-10 valent organic group;
δ is each independently an integer of 1-9;
δ′ is each independently an integer of 1-9;
R^{d} is each independently at each occurrence —Z²—CR⁸¹ₚ₂R⁸²_{q2}R⁸³ᵣ₂;
Z² is each independently at each occurrence O or a divalent organic group;
R⁸¹ is each independently at each occurrence Rd′;
R^{d′} has the same definition as that of R^{d};
in Rd, the number of C atoms which are straightly linked via the Z² group is ≤5;
R⁸² is each independently at each occurrence —Y—SiR⁸⁵ⁿ²R⁸⁶₃₋ₙ₂;
Y is each independently at each occurrence a divalent organic group;
R⁸⁵ is each independently at each occurrence OH or a hydrolyzable group;
R⁸⁶ is each independently at each occurrence H or lower alkyl;
n2 is an integer of 1-3 independently per unit (—Y—SiR⁸⁵ₙ₂R⁸⁶₃₋ₙ₂);
in formulae (D1) and (D2), at least one n2 is an integer of 1-3;
R⁸³ is each independently at each occurrence H or a lower alkyl group;
p2 is each independently at each occurrence an integer of 0-3;
q2 is each independently at each occurrence an integer of 0-3;
r2 is each independently at each occurrence an integer of 0-3;
R^{e} is each independently at each occurrence —Y—SiR⁸⁵₂R⁸⁶ₙ₂;
Rf is each independently at each occurrence H or lower alkyl;
k2 is each independently at each occurrence an integer of 0-3;
l2 is each independently at each occurrence an integer of 0-3; and
m2 is each independently at each occurrence an integer of 0-3;
in formulae (D1) and (D2), at least one q2 is 2 or 3, or at least one l2 is 2 or 3.

The composition according to any one of claims 1 to 9, wherein R^{f} is a perfluoroalkyl group having 1-16 carbon atoms.

In one embodiment, PFPE is a group of any of the following formulas (i) to (iv):

—(OCF₂CF₂CF₂)_{b1} (i)

wherein b1 is an integer of 1-200;

—(OCF(CF₃)CF₂)_{b1}— (ii)

wherein b1 is an integer of 1-200;

—(OCF₂CF₂CF₂CF₂)ₐ₁—(OCF₂CF₂CF₂)_{b1}—(OCF₂CF₂)_{c1}—(OCF₂)_{d1}— (iii)

wherein a1 and b1 are each independently 0 or an integer of 1-30, c1 and d1 are each independently an integer of 1-200, and the occurrence order of the respective repeating units in parentheses with the subscript a1, b1, c1 or d1 is not limited in the formula; or

—(R⁷—R⁸)_{f}— (iv)

wherein R⁷ is OCF₂ or OC₂F₄,
R⁸ is a group selected from OC₂F₄, OC₃F₆ and OC₄F₈; and
f is an integer of 2-100.

In one embodiment, X⁵, X⁷ and X⁹ are each independently a 2 valent organic group β, γ and δ are 1, and β′, γ′ and δ′ are 1.

In one embodiment, X5, X7 and X9 are each independently a 2 valent organic group, β, γ and δ are 1, and β′, γ′ and δ′ are 1.

In one embodiment, X⁵, X⁷ and X⁹ are each independently —(R³¹)_{p′}—(X^{a})_{q′}—

wherein:
R³¹ is each independently a single bond, —(CH₂)_{s′}—, wherein s′ is an integer of 1-20, or a o-, m- or p-phenylene group;
X^{a} is —(X^{b})_{l′}— wherein
l′ is an integer of 1-10;
X^{b} is each independently at each occurrence selected from —O—, —S—, o-, m- or p-phenylene, —C(O)O—, —Si(R³³)₂—, —(Si(R³³)₂O)_{m′}—Si(R³³)₂— (wherein m′ is an integer of 1-100), —CONR³⁴—, —O—CONR³⁴—, —NR³⁴— and —(CH₂)_{n′}— (wherein n′ is an integer of 1-20);
R³³ is each independently at each occurrence phenyl, C₁₋₆-alkyl or C₁₋₆-alkoxy;
R³⁴ is each independently at each occurrence H, phenyl or C₁₋₆-alkyl;
R³¹ and X^{a} is may be substituted with one or more substituents selected from F, C₁₋₃-alkyl and
C₁₋₃-fluoroalkyl.
p′ is 0, 1 or 2;
q′ is 0 or 1;
and at least one of p′ and q′ is 1,
and the order of the repeating units in parentheses with the subscript p′ or q′ is not limited.

In one embodiment, X⁵, X⁷ and X⁹ are each independently selected from:

—CH₂O(CH₂)₂—,
—CH₂O(CH₂)₃—,
—CH₂O(CH₂)₆—,
—CH₂O(CH₂)₃Si(CH₃)₂OSi(CH₃)₂(CH₂)₂—,
—CH₂O(CH₂)₃Si(CH₃)₂OSi(CH₃)₂OSi(CH₃)₂(CH₂)₂—,
—CH₂O(CH₂)₃Si(CH₃)₂O(Si(CH₃)₂O)₂Si(CH₃)₂(CH₂)₂—,
—CH₂O(CH₂)₃Si(CH₃)₂O(Si(CH₃)₂O)₃Si(CH₃)₂(CH₂)₂—,
—CH₂O(CH₂)₃Si(CH₃)₂O(Si(CH₃)₂O)₁₀Si(CH₃)₂(CH₂)₂—,
—CH₂O(CH₂)₃Si(CH₃)₂O(Si(CH₃)₂O)₂OSi(CH₃)₂(CH₂)₂—,
—CH₂OCF₂CHFOCF₂—,
—CH₂OCF₂CHFOCF₂CF₂—,
—CH₂OCF₂CHFOCF₂CF₂CF₂—,
—CH₂OCH₂CF₂CF₂OCF₂—,
—CH₂OCH₂CF₂CF₂OCF₂CF₂—,
—CH₂OCH₂CF₂CF₂OCF₂CF₂CF₂—,
—CH₂OCH₂CF₂CF₂OCF(CF₃)CF₂OCF₂—,
—CH₂OCH₂CF₂CF₂OCF(CF₃)CF₂OCF₂CF₂—,
—CH₂OCH₂CF₂CF₂OCF(CF₃)CF₂OCF₂CF₂CF₂—,
—CH₂OCH₂CHFCF₂OCF₂—,
—CH₂OCH₂CHFCF₂OCF₂CF₂—,
—CH₂OCH₂CHFCF₂OCF₂CF₂CF₂—,
—CH₂OCH₂CHFCF₂OCF(CF₃)CF₂OCF₂—,
—CH₂OCH₂CHFCF₂OCF(CF₃)CF₂OCF₂CF₂—,
—CH₂OCH₂CHFCF₂OCF(CF₃)CF₂OCF₂CF₂CF₂—
—CH₂OCH₂(CH₂)₇CH₂Si(OCH₃)₂OSi(OCH₃)₂(CH₂)₂Si(OCH₃)₂OSi(OCH₃)₂(CH₂)₂—,
—CH₂OCH₂CH₂CH₂Si(OCH₃)₂OSi(OCH₃)₂(CH₂)₃—,
—CH₂OCH₂CH₂CH₂Si(OCH₂CH₃)₂OSi(OCH₂CH₃)₂(CH₂)₃—,
—CH₂OCH₂CH₂CH₂Si(OCH₃)₂OSi(OCH₃)₂(CH₂)₂—,
—CH₂OCH₂CH₂CH₂Si(OCH₂CH₃)₂OSi(OCH₂CH₃)₂(CH₂)₂—,
—(CH₂)₂—, —(CH₂)₃—, —(CH₂)₄—, —(CH₂)₅—, —(CH₂)₆—, —(CH₂)₂—Si(CH₃)₂—(CH₂)₂—, —CONH—(CH₂)—,
—CONH—(CH₂)₂—, —CONH—(CH₂)₃—, —CON(CH₃)—(CH₂)₃—, —CON(Ph)-(CH₂)₃— wherein Ph is a phenyl group, —CONH—(CH₂)₆—, —CON(CH₃)—(CH₂)₆—, —CON(Ph)-(CH₂)₆— wherein Ph is a phenyl group, —CONH—(CH₂)₂NH(CH₂)₃—, —CONH—(CH₂)₆NH(CH₂)₃—, —CH₂O—CONH—(CH₂)₃— CH₂O—CONH—(CH₂)₆—, —S—(CH₂)₃—, —(CH₂)₂S(CH₂)₃—,
—CONH—(CH₂)₃Si(CH₃)₂OSi(CH₃)₂(CH₂)₂—, —CONH—(CH₂)₃Si(CH₃)₂OSi(CH₃)₂OSi(CH₃)₂(CH₂)₂—,
—CONH—(CH₂)₃Si(CH₃)₂O(Si(CH₃)₂O)₂Si(CH₃)₂(CH₂)₂—,
—CONH—(CH₂)₃Si(CH₃)₂O(Si(CH₃)₂O)₃Si(CH₃)₂(CH₂)₂—,
—CONH—(CH₂)₃Si(CH₃)₂O(Si(CH₃)₂O)₁₀Si(CH₃)₂(CH₂)₂—,
—CONH—(CH₂)₃Si(CH₃)₂O(Si(CH₃)₂O)₂OSi(CH₃)₂(CH₂)₂—, —C(O)O—(CH₂)₃—, —C(O)O—(CH₂)₆—,
—CH₂—O—(CH₂)₃—Si(CH₃)₂—(CH₂)₂—Si(CH₃)₂—(CH₂)₂—,
—CH₂—O—(CH₂)₃—Si(CH₃)₂—(CH₂)₂—Si(CH₃)₂—CH(CH₃)—,
—CH₂—O—(CH₂)₃—Si(CH₃)₂—(CH₂)₂—Si(CH₃)₂—(CH₂)₃—,
—CH₂—O—(CH₂)₃—Si(CH₃)₂—(CH₂)₂—Si(CH₃)₂—CH(CH₃)—CH₂—, —OCH₂—, —O(CH₂)₃—, —OCFHCF₂—,

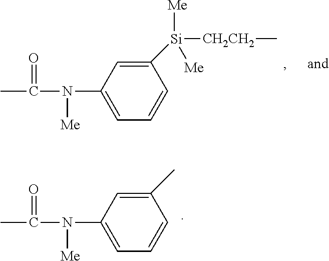

In one embodiment, The composition according to any one of claims 1 to 15, wherein k1 is 3, and q1 is 3 in R^{a}.

In one embodiment, l2 is 3, and n2 is 3.

In one embodiment, Y is C₁₋₆-alkylene, —(CH₂)_{g′}—O—(CH₂)_{h′}— (wherein g′ is an integer of 0-6, and h′ is an integer of 0-6), or -phenylene-(CH₂)_{i′}— (wherein i′ is an integer of 0-6).

In one embodiment, X⁵, X⁷ and X⁹ are each independently a 3-10 valent organic group.

In one embodiment, X⁷ and X⁹ are each independently selected from:

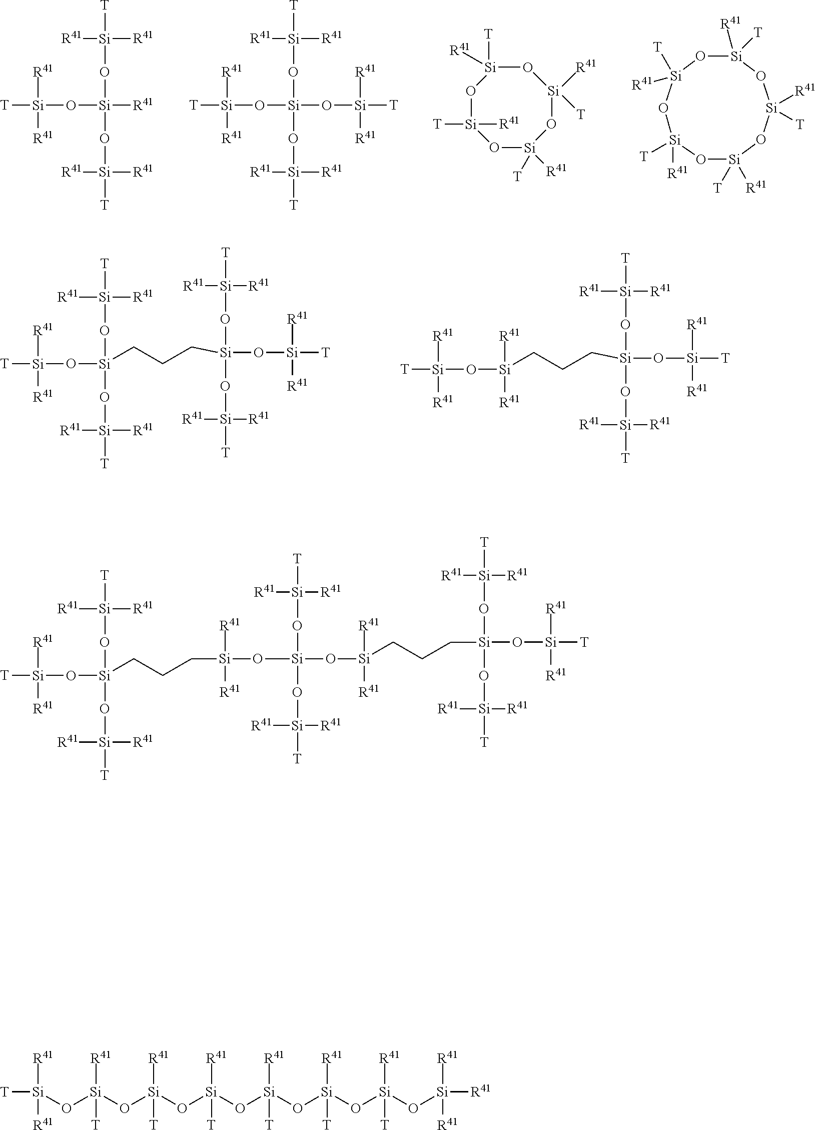

wherein in each group, at least one of T is the following group attached to PFPE in the formulae (A1), (A2), (B1), (B2), (C1), (C2), (D1) and (D2):

—CH₂O(CH₂)₂—,
—CH₂O(CH₂)₃—,
—CF₂O(CH₂)₃—,
—(CH₂)₂—,
—(CH₂)₃—,
—(CH₂)₄—,

### —CONH—(CH₂)—,

—CONH—(CH₂)₂—,
—CONH—(CH₂)₃—,
—CON(CH₃)—(CH₂)₃—,
—CON(Ph)-(CH₂)₃— wherein Ph is phenyl, and

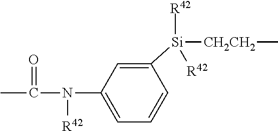

at least one of the other T is —(CH₂)ₙ— (wherein n is an integer of 2-6) attached to the carbon atom or the Si atom in the formulae (A1), (A2), (B1), (B2), (C1), (C2), (D1) and (D2), and if present, the others T are each independently methyl, phenyl, C1-6-alkoxy, or a radical scavenger group or an ultraviolet ray absorbing group,

R⁴¹ is each independently H, phenyl, C₁₋₆-alkoxy or C₁₋₆-alkyl, and
R⁴² is each independently H, C₁₋₆-alkyl or C₁₋₆-alkoxy.

In another aspect, provided is an article comprising a base material and a surface treating layer disposed on a surface of the base material, wherein the surface treating layer is formed from a composition in accordance with any of the previous embodiments.

In one embodiment, the base material is selected from a glass, a sapphire glass, a resin, a metal, a ceramic, a semiconductor, a fiber, a fur, a leather, a wood, a pottery, or a stone.

In still another aspect, provided is a method of forming an article comprising applying a composition in accordance with any of the previous embodiments, to a surface of a base material to form a coating layer.

In one embodiment, the method comprises treating the coating layer with water subsequent to the formation of the coating layer.

In one embodiment, the method comprises heating the coating under a dry atmosphere.

In one embodiment, treating the coating layer with water and heating the coating is performed by exposing the coating to superheated water vapor.

The following description and the drawings disclose various illustrative aspects. Some improvements and novel aspects may be expressly identified, while others may be apparent from the description and drawings.

### BRIEF DESCRIPTION OF THE DRAWINGS

The accompanying drawings illustrate various systems, apparatuses, devices and related methods, in which like reference characters refer to like parts throughout, and in which:

FIG. 1 non-limiting examples of hybrid oligomers.

### DETAILED DESCRIPTION

Reference will now be made to exemplary embodiments, examples of which are illustrated in the accompanying drawings. It is to be understood that other embodiments may be utilized and structural and functional changes may be made. Moreover, features of the various embodiments may be combined or altered. As such, the following description is presented by way of illustration only and should not limit in any way the various alternatives and modifications that may be made to the illustrated embodiments. In this disclosure, numerous specific details provide a thorough understanding of the subject disclosure. It should be understood that aspects of this disclosure may be practiced with other embodiments not necessarily including all aspects described herein, etc.

As used herein, the words “example” and “exemplary” means an instance, or illustration. The words “example” or “exemplary” do not indicate a key or preferred aspect or embodiment. The word “or” is intended to be inclusive rather than exclusive, unless context suggests otherwise. As an example, the phrase “A employs B or C,” includes any inclusive permutation (e.g., A employs B; A employs C; or A employs both B and C). As another matter, the articles “a” and “an” are generally intended to mean “one or more” unless context suggest otherwise.

Disclosed herein is a composition for treating a surface comprising (i) a hybrid siloxane oligomer comprising fluoro functional groups and organo functional groups, and (ii) a pefluoro(poly)ether group containing silane. The composition can impart water resistance, oil resistance, and other properties to a substrate coated with the surface treating composition.

Hybrid Siloxane Oligomer

The hybrid siloxane oligomer is a siloxane functional oligomer comprising a fluoro-functional group and a reactive and/or non-reactive functional group. The reactive functional groups allow for the oligomers to be hydrolyzed and condensed to form a coating on a surface. Further, the fluoro-functional groups and other functional groups of the siloxane oligomer provide additional properties, e.g., hydrophobic and/or oleophobic properties, antifouling, etc., to a surface upon coating.

The hybrid siloxane oligomer, in one embodiment, is a compound of the formula (1):

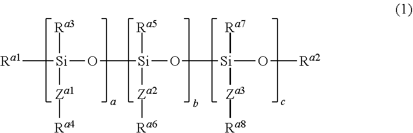

where R^{a1}, R^{a3}, R^{a5}, and R^{a7} are each independently selected from hydroxy, an alkoxy, an alkoxycarbonyl, a halide, an alkyl, an aralkyl, or an aromatic group, with the proviso that at least one of R^{a1}, R^{a3}, R^{a5}, and/or R^{a7} is an alkoxy, an alkoxycarbonyl, or a halide group;
R^{a2} is selected from hydrogen, an alkyl, an aralkyl, or an aromatic group;
R^{a4} is represented by the formula C_{z}H_{y}Fₓ where z is 1-20 and x+y is 2z+1 where x is 1 or greater;
R^{a6} and R^{a8} are each independently selected from an alkoxy, an alkoxycarbonyl, a halide, an alkyl, an aralkyl, an aromatic group, an epoxy, an amine;
Z^{a1}, Z^{a2}, and Z^{a3} are each independently selected from an organic linking group having 1-20 carbon atoms optionally containing heteroatoms, with the proviso that when R^{a6} or R^{a8} is an alkoxy, an alkoxycarbonyl, or a halide, then Z^{a2} or Z^{a3}, respectively, cannot be O, N, or S;
a, b, and c are each independently 0 to about 100, a+b+c is greater than 0, a is greater than 0, and b+c is greater than 0.

The alkoxy group can be selected from a group —OR^{a9} where R^{a9} is a C1-C10 alkyl, a C2-C8 alkyl, or a C4-C6 alkyl. In one embodiment, the alkoxy group is —OCH₃.

The alkoxycarbonyl group can be selected form a group of the formula —O—C(O)—OR^{a10}, where R^{a10} is a C1-C10 alkyl, a C2-C8 alkyl, or a C4-C6 alkyl. In one embodiment, the alkoxycarbonyl group is —O—C(O)—OCH₃.

The halide group can be selected from Br, Cl, F, or I. In one embodiment when at least one of R^{a1}, R^{a3}, R^{a5}, R^{a7}, R^{a6}, or R^{a8} is a halide, the halide is F.

The alkyl groups can be selected from a linear, branched, or cyclic alkyl group. In one embodiment, the alkyl group is selected from a C1-C20 alkyl, a C2-C16 alkyl, a C3-C10 alkyl, or a C4-C6 alkyl. In one embodiment, the alkyl group is selected from a C4-C20 cyclic alkyl, a C5-C16 cyclic alkyl, or a C6-C10 cyclic alkyl. In embodiments, the alkyl group is selected from methyl, ethyl, propyl, isopropyl, butyl, isobutyl, t-butyl, pentyl, hexyl, heptyl, octyl, nonyl, decyl, etc.

The alcohol groups can be selected from —OH or —R^{a11}OH, where R^{a11} is a C1-C10 alkyl group.

The aromatic groups can be selected from an aromatic hydrocarbon from which one hydrogen atom has been removed. An aromatic group may have one or more aromatic rings, which may be fused, or connected by single bonds or other groups. In embodiments, an aromatic group may be chosen from a C6-C30 aromatic, a C6-C20 aromatic, even a C6-C10 aromatic. Specific and non-limiting examples of aromatic groups include, but are not limited to, tolyl, xylyl, phenyl, and naphthalenyl.

R^{a4} is represented by the formula C_{z}H_{y}Fₓ where z is 1-20 and x+y is 2z+1 where x is 1 or greater. In on embodiment, z is 1 to about 20, about 2 to about 10, or about 4 to about 6. In one embodiment, when y is 0, the fluoro-functional group is a perfluorinated aliphatic group of the formula C_{z}F_{2z+1}. In one embodiment, the fluoro-functional group is selected from —CF₃, —C₂F₅, —C₃F₇, —C₄F₉, —C₅F₁₁, or —C₆F₁₃.

R^{a6} and R^{a8} are each independently selected from an alkoxy, an alkoxycarbonyl, a halide, an alkyl, an aralkyl, an aromatic group, an epoxy, an amine. The alkoxy, alkoxycarbonyl, halide, alkyl, and aromatic groups can be selected from any such group as previously described herein.

In one embodiment R^{a6} and R^{a8} as can be selected from an amine. The amine can be substituted with H, an alkyl group, a cycloalkyl group, or an aromatic group. The amine can also be chosen from a polyamine group. In one embodiment, the amine group is selected from —NR₂^{a12}, —(NR^{a13})ₕ—NR^{a14}R^{a15}, —NR^{a16}—C(X¹)—NR₂^{a17}, —R^{a18}—N(R^{a19})—R^{a20}, —R^{a21}—NR₂^{a22}, —R^{a23}—(N(R^{a24}))ᵢ—R^{a25}—N₂^{a26}, or a combination of two or more thereof, where R^{a12}, R^{a13}, R^{a14}, R^{a15}, R^{a16}, R^{a17}, R^{a19}, R^{a22}, R^{a24}, and R^{a26} are each independently selected from hydrogen, C1-C20 alkyl, a C6-C20 cycloalkyl, or a C6-C20 aromatic, R^{a18}, R^{a20}, R^{a21}, R^{a23}, and R^{a25} are each independently selected from a divalent C1-C20 alkyl, a C6-C20 cycloalkyl, or a C6-C20 aromatic group, X¹ is O or S, h is 1 to about 10, and i is 1 to about 10. In embodiments, the amine is selected from —NH₂, —N(CH₃)₂, —NH—C(O)—NH₂, —NH—C(S)—NH₂, —(NH(C₂H₄)—)₂NH₂, or a combination of two or more thereof.

In one embodiment, R⁶ and R⁸ can be selected from a thiol (—SH) containing group. Examples of thiol containing groups include, but are not limited to, —SH, —SR^{a27}, —S—C(O)—R^{a28}, or a combination of two or more thereof, where R²⁷ and R²⁸ are each independently selected from a C1-C10 alkyl, a C6-C20 cycloalkyl, and a C6-C20 aromatic.

In one embodiment, R⁶ and R⁸ can be selected from an epoxy functional group. The epoxy functional group can be selected from —R^{a29}-epoxy; or —R^{a30}—O—R^{a31}-epoxy, where R^{a29}, R^{a30}, and R^{a31} are independently selected from a divalent C1-C20 alkyl, a C6-C20 cycloalkyl, or a C6-C20 aromatic, R^{a29} and R^{a31} can also be or can be a ring structure to form a C5-C20 cycloalkyl epoxy.

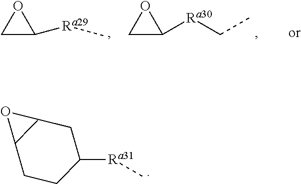

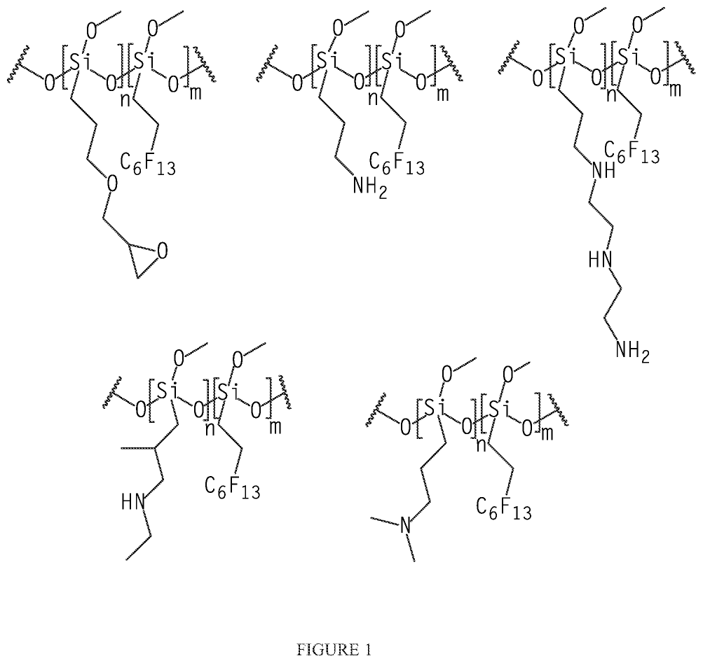

FIG. 1 shows some non-limiting examples of hybrid oligomers within the scope of the present technology.

The hybrid oligomers are provided such that the molar ratio of fluoro groups (R^{a4}) to the organo functional groups (R^{a6} and/or R^{a8}) is from about 1:9 to about 9:1, from about 1:7 to about 7:1, from about 1:5 to about 5:1; from about 1:3 to about 3:1, from about 1:2 to about 2:1, or about 1:1. In one embodiment, the molar ratio of fluoro groups to organo functional groups is about 1:1 to about 4:1, from about 1.5:1 to about 3:1, or about 2:1 to about 2.5:1.

In one embodiment, the hybrid siloxane (and its partially hydrolyzed condensate) has a number average molecular weight are preferably at least 300, more preferably at least 500, more preferably at least 1000. In one embodiment, the number average molecular weight of the hybrid siloxane compound (1) (and the compound's partially hydrolyzed condensate) are at most 10000, at most 5000, or at most 3000. In embodiments, the number average molecular weight is from about 300 to about 10000, from about 500 to about 7500, from about 1000 to about 5000, or from about 2000 to about 3000. As used herein, the “number average molecular weight” is measured by GPC (Gel Permeation Chromatography) analysis.

The hybrid siloxane oligomers are generally prepared by reacting a fluorosilane with an appropriate reactive and/or non-reactive functional silane in the presence of a solvent and a catalyst. The silanes can be reacted at a temperature of from about 20° C. to about 60° C. Following the reaction, any water or volatiles can be removed to obtain the hybrid siloxane oligomer product. In one embodiment, a hybrid siloxane oligomer can be prepared by the reaction of a silane (R^{a4}—Z^{a1})Si(OR^{a3})₂(OR^{a1}) with the silanes (R^{a6}—Z²)Si(OR^{a5})₃₋ₙ(OR^{a2})ₙ and/or (R^{a8}—Z^{a3})Si(OR^{a7})₂(OR^{a2}), where R^{a1}, R^{a2}, R^{a3}, R^{a4}, R^{a5}, R^{a6}, R^{a7}, R^{a8}, Z^{a1}, Z^{a2}, and Z^{a3} are as described above. The respective silanes can be provided in the desired molar ratios (satisfying a, b, and c as described above). The solvent can be selected as desired for a particular purpose or intended application. In embodiments, the solvent can be an alcohol (e.g., a C1-C10 alcohol) or a fluoro substituted alcohol. In one embodiment, the solvent is selected from methanol or trifluoroethanol.

The catalyst can be selected as desired for a particular purpose or intended application. Examples of suitable solvents include, but are not limited to, hydrochloric acid, nitric acid, sulfuric acid, phosphoric acid, fluoric acid, formic acid, acetic acid, propionic acid, butanoic acid, pentanoic acid, hexanoic acid, monochloroacetic acid, dichloroacetic acid, trichloroacetic acid, trifluoroacetic acid, oxalic acid, malonic acid, sulfonic acid, phthalic acid, fumaric acid, citric acid, maleic acid, methylmalonic acid, adipic acid, p-toluenesulfonic acid, an ammonia solution, or combinations of two or more thereof.

Water and volatiles are removed from the reaction mixture to obtain the hybrid siloxane oligomer product. Water can be removed from the mixture using any suitable agent such as, but not limited to, calcium carbonate, sodium bicarbonate, anhydrous sodium sulfate, and the like. Volatiles can be removed from the mixture using any suitable method as is known in the art. In one embodiment, volatiles are removed under pressure (i.e., at reduced pressure) and/or at elevated temperatures. The temperature may be selected as desired based on the solvent or other organic materials employed in the reaction mixture.

The degree of cross linking can be evaluated based on the ratio of “T” units as evaluated by ²⁹Si NMR. It will be appreciated that the ratio of T⁰, T¹, T², and T³ units is indicative of the degree of cross linking in the system (i.e., the extent of hydrolysis and condensation in the product). This can be altered or controlled by reaction conditions including the dosage of catalyst and/or the time of the reaction. Generally, the degree of cross linking and the ratio of T⁰, T¹, T², and T³ units may be selected as desired for a particular purpose or intended application or coating application.

Perfluoro(poly)ether Group Containing Silane

The surface treating composition comprises a perfluoro(poly)ether group containing silane. The perfluoro(poly)ether group containing silane can be a compound of the formula (2) and/or (3):

[A]_{b1}Q²[B]_{b2} Formula (2) and/or

[B]_{b2}Q²[A]Q²[B]_{b2} Formula (3)

where, Q² is a linking group having a valency of (b1+b2),
A is a group represented by R^{f3}—O—R^{f2}— or —R^{f3}—O—R^{f2}—, where R^{f2} is a poly(oxyfluoroalkylene) chain, and R^{f3} is a perfluoroalkyl group or perfluoroalkylene group,
B is a monovalent group having one —R¹²—(SiR²ᵣ—X²₃₋ᵣ), where R¹² is a organic group preferably hydrocarbon group having 2 to 10 carbon atoms that optionally has an ether oxygen atom between the carbon-carbon atoms or at an end opposite to a side bonded with Si or optionally has —NH— between the carbon-carbon atoms, R² are each independently a hydrogen atom or a monovalent hydrocarbon group having 1 to 6 carbon atoms, the hydrocarbon group optionally containing a substituent, X² are each independently a hydroxyl group or a hydrolyzable group, and r is an integer of 0 to 2, and including no fluorine atom,
Q² and B include no cyclic siloxane structure,
b1 is an integer of 1 to 3,
b2 is an integer of 1 to 9, and
in a case where b1 is 2 or more, b1 pieces of A may be identical or different, and
b2 pieces of B may be identical or different.

In one embodiment, R² in Formula (2) and/or Formula (3) is a group represented by —(CₐᵢF₂ₐᵢO)ₙ—, where ai is an integer of 1 to 6, n is an integer of 2 or more, and the —CₐF₂ₐO— units may be identical or different. In embodiments, R^{f2} in Formula (2) and/or Formula (3) is a group represented by a group —(CF₂CF₂CF₂CF₂CF₂CF₂O)ₙ₁—(CF₂CF₂CF₂CF₂CF₂O)ₙ₂—(CF₂CF₂CF₂CF₂O)ₙ₃—(CF₂CF₂CF₂O)ₙ₄—(CF(CF₃)CF₂O)ₙ₅—(CF₂CF₂O)ₙ₆—(CF₂O)ₙ₇—, where n1, n2, n3, n4, n5, n6, and n7 are each independently an integer of 0 or more, the sum of n1, n2, n3, n4, n5, n6, and n7 is 2 or more, and the repeating units may exist in block, alternately, or randomly.

In one embodiment, the pefluoro(poly)ether group containing silane compound can be a compound of any of the formulae (A1), (A2), (B1), (B2), (C1), (C2), (D1) and (D2) as shown and described in U.S. Publication 2019/0031828, which is incorporated herein by reference in its entirety. The compound of formula (2) can be selected from compound selected from the group consisting of (A1), (A2), (B1), (B2), (C1), (C2), (D1) and (D2):

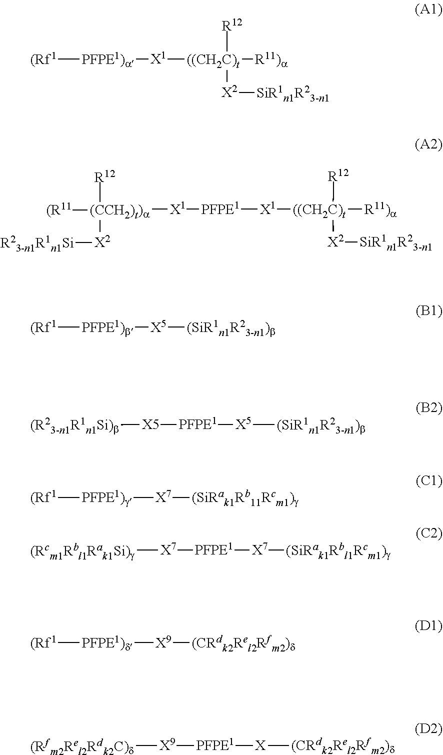

In the formula described above, PFPE is each independently —(OC₄F₈)ₐ₁—(OC₃F₆)_{b1}—(OC₂F₄)_{c1}—(OCF₂)_{d1}—, and corresponds to a perfluoro(poly)ether group. Herein, a, b, c and d are each independently 0 or an integer of 1 or more. The sum of a1, b1, c1, and d1 is 1 or more. Preferably, a1, b1, c1, and d1 are each independently an integer of 0 or more and 200 or less, for example an integer of 1 or more and 200 or less, more preferably each independently an integer of 0 or more and 100 or less. The sum of a1, b1, c1 and d1 is preferably 5 or more, more preferably 10 or more, for example 10 or more and 100 or less. The occurrence order of the respective repeating units in parentheses with the subscript a1, b1, c1, or d1 is not limited in the formula. Among these repeating units, the —(OC₄F₈)— group may be any of —(OCF₂CF₂CF₂CF₂)—, —(OCF(CF₃)CF₂CF₂)—, —(OCF₂CF(CF₃)CF₂)—, —(OCF₂CF₂CF(CF₃))—, —(OC(CF₃)₂CF₂)—, —(OCF₂C(CF₃)₂)—, —(OCF(CF₃)CF(CF₃))—, —(OCF(C₂F₈)CF₂)— and —(OCF₂CF(C₂F))—, preferably —(OCF₂CF₂CF₂CF₂)—. The —(OC₃F₆)— group may be any of —(OCF₂CF₂CF₂)—, —(OCF(CF₃)CF₂)— and —(OCF₂CF(CF₃))—, preferably —(OCF₂CF₂CF₂)—. The —(OC₂F₄)— group may be any of —(OCF₂CF₂)— and —(OCF(CF₃))—, preferably —(OCF₂CF₂)—.

In one embodiment, PFPE is —(OC₃F₆)_{b1}— wherein b is an integer of 1 or more and 200 or less, preferably 5 or more and 200 or less, more preferably 10 or more and 200 or less, preferably —(OCF₂CF₂CF₂)_{b1}— wherein b1 is an integer of 1 or more and 200 or less, preferably 5 or more and 200 or less, more preferably 10 or more and 200 or less, or —(OCF(CF₃)CF₂)_{b1}— wherein b1 is an integer of 1 or more and 200 or less, preferably 5 or more and 200 or less, more preferably 10 or more and 200 or less, more preferably —(OCF₂CF₂CF₂)_{b1}— wherein b1 is an integer of 1 or more and 200 or less, preferably 5 or more and 200 or less, more preferably 10 or more and 200 or less.

In another embodiment, PFPE is —(OC₄F₈)ₐ₁—(OC₃F₆)_{b1}—(OC₂F₄)_{c1}—(OCF₂)ₐ₁— wherein a1 and b1 are each independently an integer of 0 or more and 30 or less, c1 and d1 are each independently an integer of 1 or more and 200 or less, preferably 5 or more and 200 or less, more preferably 10 or more and 200 or less, and the occurrence order of the respective repeating units in parentheses with the subscript a, b, c or d is not limited in the formula; preferably —(OCF₂CF₂CF₂CF₂)ₐ₁—(OCF₂CF₂CF₂)_{b1}—(OCF₂CF₂)_{c1}—(OCF₂)ₐ₁—. In one embodiment, PFPE may be —(OC₂F₄)_{c1}—(OCF₂)ₐ₁— wherein c and d are each independently an integer of 1 or more and 200 or less, preferably 5 or more and 200 or less, more preferably 10 or more and 200 or less, and the occurrence order of the respective repeating units in parentheses with the subscript c or d is not limited in the formula.

In a further another embodiment, PFPE is a group of —(R⁷—R⁸)_{f}—. In the formula, R¹ is OCF₂ or OC₂F₄, preferably OC₂F₄. That is, preferably PFPE is a group of —(OC₂F₄—R⁸)_{f}—. In the formula, R⁸ is a group selected from OC_{Z}F₄, OC₃F₆ and OC₄F₈, or a combination of 2 or 3 groups independently selected from these groups. Examples of the combination of 2 or 3 groups independently selected from OC₂F₄, OC₃F₆ and OC₄F₈ include, but not limited to, for example, —OC₂F₄OC₃F₆—, —OC₂F₄OC₄F₈—, —OC₃F₆OC₂F₄—, —OC₃F₆OC₃F₆—, —OC₃F₆OC₄F₈—, —OC₄F₈OC₄F₈—, —OC₄F₈OC₃F₆—, —OC₄F₈OC F₄—, —OC₂F₄OC₂F₄OC₃F₆—, —OC₂F₄OC₄F₄OC₄F₈—, —OC₂F₄OC₃F₆OC₂F₄—, —OC₂F₄OC₃F₆OC₃F₆—, —OC₂F₄OC₄F OCz F₄—, —OC₃F₆OC₂F₄OC₂F₄—, —OC₃F₆OC₂F₄OC₃F₆—, —OC₃F₆OC₃F₆OCF₄—, —OC₄F₄OC₂F₄OC₂F₄—, and the like. f is an integer of 2-100, preferably an integer of 2-50. In the above-mentioned formula, OC₂F₄, OC₃F₆ and OC₄F₈ may be straight or branched, preferably straight. In this embodiment, PFPE is preferably —(OC₂F₄—OC₃F₆)_{f}— or —(OC₂F₄—OC₄F₈)_{f}—.

In the formula, R^{f} is an alkyl group having 1-16 carbon atoms which may be substituted by one or more fluorine atoms.

The “alkyl group having 1-16 carbon atoms” in the alkyl having 1-16 carbon atoms which may be substituted by one or more fluorine atoms may be straight or branched, and preferably is a straight or branched alkyl group having 1-6 carbon atoms, in particular 1-3 carbon atoms, more preferably a straight alkyl group having 1-3 carbon atoms.

R^{f} is preferably an alkyl having 1-16 carbon atoms substituted by one or more fluorine atoms, more preferably a CF₂H—C₁₋₁₅ fluoroalkylene group, more preferably a perfluoroalkyl group having 1-16 carbon atoms.

The perfluoroalkyl group having 1-16 carbon atoms may be straight or branched, and preferably is a straight or branched perfluoroalkyl group having 1-6 carbon atoms, in particular 1-3 carbon atoms, more preferably a straight perfluoroalkyl group having 1-3 carbon atoms, specifically —CF₃, —CF₂CF₃ or —CF₂CF₂CF₃.

In the formula, R¹ is each independently at each occurrence a hydroxyl group or a hydrolyzable group.

In the formula, R² is each independently at each occurrence a hydrogen atom or an alkyl group having 1-22 carbon atoms preferably an alkyl group having 1-4 carbon atoms.

The “hydrolyzable group” as used herein represents a group which is able to be removed from a backbone of a compound by a hydrolysis reaction. Examples of the hydrolyzable group include —OR, —OCOR, —O—N═CR₂, —NR₂, —NHR, halogen (wherein R is a substituted or non-substituted alkyl group having 1-4 carbon atoms), preferably —OR (i.e. an alkoxy group). Examples of R include a non-substituted alkyl group such as a methyl group, an ethyl group, a propyl group, an isopropyl group, an n-butyl group, an isobutyl group; and a substituted alkyl group such as a chloromethyl group. Among them, an alkyl group, in particular a non-substituted alkyl group is preferable, a methyl group or an ethyl group is more preferable. The hydroxyl group may be, but is not particularly limited to, a group generated by hydrolysis of a hydrolyzable group.

In the formula, R¹¹ is each independently at each occurrence a hydrogen atom or a halogen atom. The halogen atom is preferably an iodine atom, a chlorine atom, a fluorine atom, more preferably a fluorine atom.

In the formula, R¹² is each independently at each occurrence a hydrogen atom or a lower alkyl group. The lower alkyl group is preferably an alkyl group having 1-20 carbon atoms, more preferably an alkyl group having 1-6 carbon atoms, for example a methyl group, an ethyl group, an propyl group, or the like.

In the formula, n1 is, independently per a unit (—SiR¹ₙ₁R²₃₋ₙ₁), an integer of 0-3, preferably 0-2, more preferably 0. All of n1 are not simultaneously 0 in the formula. In other words, at least one R¹ is present in the formula.

In the formula, X¹ is each independently a single bond or a 2-10 valent organic group. X¹ is recognized to be a linker which connects between a perfluoropolyether moiety (i.e., an Rf-PFPE moiety or -PFPE- moiety) providing mainly water-repellency, surface slip property and the like and a silane moiety (i.e., a group in parentheses with the subscript a) providing an ability to bind to a base material in the compound of the formula (A1) and (A2) Therefore, X¹ may be any organic group as long as the compound of the formula (A1) and (A2) can stably exist.

In the formula, a is an integer of 1-9, and α′ is an integer of 1-9. α and α′ may be varied depending on the valence number of the X¹ group. In the formula (A1), the sum of a and α′ is the valence number of X¹. For example, when X¹ is a 10 valent organic group, the sum of α and α′ is 10, for example, a is 9 and α′ is 1, a is 5 and α′ is 5, or α is 1 and α′ is 9. When X¹ is a divalent organic group, a and α′ are 1. In the formula (A2), a is a value obtained by subtracting 1 from the valence number of X¹.

X¹ is preferably a 2-7 valent, more preferably 2-4 valent, more preferably a divalent organic group.

In one embodiment, X¹ is a 2-4 valent organic group, a is 1-3, and α′ is 1.

In embodiments of (A1), (A2), (B1), (C1), (C2), (D1), and (D2) PFPE is each independently at each occurrence a group of the formula:

—(OC₄F₈)ₐ₁—(OC₃F₆)_{b1}—(OC₂F₄)_{c1}—(OCF₂)_{d1}—

wherein a1, b1, c1 and d1 are each independently an integer of 0-200 with (a1+b1+c1+d1)≥1, and the order of the repeating units in parentheses with the subscripts a1-d1 is not limited;

R^{f1} is each independently at each occurrence C1-16-alkyl optionally substituted by F;
R¹ is each independently at each occurrence OH or a hydrolyzable group;
R² is each independently at each occurrence H or C1-22-alkyl;
R¹¹ is each independently at each occurrence H or halogen;
R12 is each independently at each occurrence H or lower alkyl;
   n1 is, independently per a unit (—SiR¹ₙ₁R²₃₋ₙ₁), an integer of 0-3;
at least one n1 is an integer of 1-3 in the formulae (A1), (A2), (B1) and (B2);
   X¹ is each independently a single bond or a 2-10 valent organic group;
   X² is each independently at each occurrence a single bond or a divalent organic group;
   t is each independently at each occurrence an integer of 1-10;
   α is each independently an integer of 1-9;
   α′ is each independently an integer of 1-9;
   X⁵ is each independently a single bond or a 2-10 valent organic group;
   β is each independently an integer of 1-9;
   β′ is each independently an integer of 1-9;
   X⁷ is each independently a single bond or a 2-10 valent organic group;
   γ is each independently an integer of 1-9;
   γ′ is each independently an integer of 1-9;
   R^{a} is each independently at each occurrence —Z¹—SiR⁷¹ₚ₁R⁷²_{q}R⁷³ᵣ₁;
   Z¹ is each independently at each occurrence O or a divalent organic group;
   R⁷¹ is each independently at each occurrence R^{a′} having the same definition as R^{a};
   R⁷² is each independently at each occurrence OH or a hydrolyzable group;
   R⁷³ is each independently at each occurrence H or lower alkyl;
   p1 is each independently at each occurrence an integer of 0-3;
   q1 is each independently at each occurrence an integer of 0-3;
   r1 is each independently at each occurrence an integer of 0-3;

at least one q1 is an integer of 1-3 in the formula (C1) and (C2);

and in R^{a} the number of Si atoms which are straightly linked via the Z1 group is ≤5;
R^{b} is each independently at each occurrence OH or a hydrolyzable group;
R^{c} is each independently at each occurrence H or lower alkyl;
k1 is each independently at each occurrence an integer of 1-3;
l1 is each independently at each occurrence an integer of 0-2;
m1 is each independently at each occurrence an integer of 0-2;
and (k1+l1+m1)=3 in each unit in parentheses with the subscript γ;
   X⁹ is each independently a single bond or a 2-10 valent organic group;
   δ is each independently an integer of 1-9;
   δ′ is each independently an integer of 1-9;
   R^{d} is each independently at each occurrence —Z²—CR⁸¹ₚ₂R⁸²_{q2}R⁸³ᵣ₂;
   Z2 is each independently at each occurrence O or a divalent organic group;
   R81 is each independently at each occurrence R^{d′};
   R^{d′} has the same definition as that of R^{d};
in R^{d}, the number of C atoms which are straightly linked via the Z² group is ≤5;
   R⁸² is each independently at each occurrence —Y—SiR⁸⁵ₙ₂R⁸⁶₃₋ₙ₂;
   Y is each independently at each occurrence a divalent organic group;
   R⁸⁵ is each independently at each occurrence OH or a hydrolyzable group;
   R⁸⁶ is each independently at each occurrence H or lower alkyl;
   n2 is an integer of 1-3 independently per unit (—Y—SiR⁸⁵ₙ₂R⁸⁶₃₋ₙ₂);
in formulae (D1) and (D2), at least one n2 is an integer of 1-3;
   R⁸³ is each independently at each occurrence H or a lower alkyl group;
   p2 is each independently at each occurrence an integer of 0-3;
   q2 is each independently at each occurrence an integer of 0-3;
   r2 is each independently at each occurrence an integer of 0-3;
   R^{e} is each independently at each occurrence —Y—SiR⁸⁵ₙ₂R⁸⁶ₙ₂;
   R^{f} is each independently at each occurrence H or lower alkyl;
   k2 is each independently at each occurrence an integer of 0-3;
   l2 is each independently at each occurrence an integer of 0-3; and
   m2 is each independently at each occurrence an integer of 0-3;
   in formulae (D1) and (D2), at least one q2 is 2 or 3, or at least one l2 is 2 or 3

In one embodiment, PFPE is a group of any of the following formulas (i) to (iv):

—(OCF₂CF₂CF₂)_{b1} (i)

wherein b is an integer of 1-200;

—(OCF(CF₃)CF₂)_{b1}— (ii)

wherein b is an integer of 1-200;

—(OCF₂CF₂CF₂CF₂)ₐ₁—(OCF₂CF₂CF₂)_{b1}—(OCF₂CF₂)_{c1}—(OCF₂)_{d1}— (iii)

wherein a1 and b1 are each independently 0 or an integer of 1-30, c1 and d1 are each independently an integer of 1-200, and the occurrence order of the respective repeating units in parentheses with the subscript a1, b1, c1, or d1 is not limited in the formula; or

—(R⁷—R⁸)_{f}— (iv)

wherein R⁷ is OCF₂ or OC₂F₄,
R⁸ is a group selected from OC₂F₄, OC₃F₆ and OC₄F₈; and
f is an integer of 2-100.

In one embodiment, X⁵, X⁷ and X⁹ are each independently a 2 valent organic group β, γ and δ are 1, and β′, γ′ and δ′ are 1.

In one embodiment, X⁵, X⁷ and X⁹ are each independently —(R³¹)_{p′}—(X^{a})_{q′}—

wherein:
R³¹ is each independently a single bond, —(CH₂)_{s′}— (wherein s′ is an integer of 1-20) or a o-, m- or p-phenylene group;
X^{a} is —(X^{b})_{l′}— wherein
l′ is an integer of 1-10;
X^{b} is each independently at each occurrence selected from —O—, —S—, o-, m- or p-phenylene, —C(O)O—, —Si(R³³)₂—, —(Si(R³³)₂O)_{m′}—Si(R³³)₂— (wherein m′ is an integer of 1-100), —CONR³⁴—, —O—CONR³⁴—, —NR³⁴— and —(CH₂)_{n′}— (wherein n′ is an integer of 1-20);
R³³ is each independently at each occurrence phenyl, C₁₋₆-alkyl or C₁₋₆-alkoxy;
R³⁴ is each independently at each occurrence H, phenyl or C₁₋₆-alkyl;
R³¹ and X^{a} is may be substituted with one or more substituents selected from F, C₁₋₃-alkyl and C₁₋₃-fluoroalkyl.
   p′ is 0, 1 or 2;
   q′ is 0 or 1;
and at least one of p′ and q′ is 1,
and the order of the repeating units in parentheses with the subscript p′ or q′ is not limited.

In one embodiment, X⁵, X⁷ and X⁹ are each independently selected from:

—CH₂O(CH₂)₂—,
—CH₂O(CH₂)₃—,
—CH₂O(CH₂)₆—,
—CH₂O(CH₂)₃Si(CH₃)₂OSi(CH₃)₂(CH₂)₂—,
—CH₂O(CH₂)₃Si(CH₃)₂OSi(CH₃)₂OSi(CH₃)₂(CH₂)₂—,
—CH₂O(CH₂)₃Si(CH₃)₂O(Si(CH₃)₂O)₂Si(CH₃)₂(CH₂)₂—,
—CH₂O(CH₂)₃Si(CH₃)₂O(Si(CH₃)₂O)₃Si(CH₃)₂(CH₂)₂—,
—CH₂O(CH₂)₃Si(CH₃)₂O(Si(CH₃)₂O)₁₀Si(CH₃)₂(CH₂)₂—,
—CH₂O(CH₂)₃Si(CH₃)₂O(Si(CH₃)₂O)₂OSi(CH₃)₂(CH₂)₂—,
—CH₂OCF₂CHFOCF₂—,
—CH₂OCF₂CHFOCF₂CF₂—,
—CH₂OCF₂CHFOCF₂CF₂CF₂—,
—CH₂OCH₂CF₂CF₂OCF₂—,
—CH₂OCH₂CF₂CF₂OCF₂CF₂—,
—CH₂OCH₂CF₂CF₂OCF₂CF₂CF₂—,
—CH₂OCH₂CF₂CF₂OCF(CF₃)CF₂OCF₂—,
—CH₂OCH₂CF₂CF₂OCF(CF₃)CF₂OCF₂CF₂—,
—CH₂OCH₂CF₂CF₂OCF(CF₃)CF₂OCF₂CF₂CF₂—,
—CH₂OCH₂CHFCF₂OCF₂—,
—CH₂OCH₂CHFCF₂OCF₂CF₂—,
—CH₂OCH₂CHFCF₂OCF₂CF₂CF₂—,
—CH₂OCH₂CHFCF₂OCF(CF₃)CF₂OCF₂—,
—CH₂OCH₂CHFCF₂OCF(CF₃)CF₂OCF₂CF₂—,
—CH₂OCH₂CHFCF₂OCF(CF₃)CF₂OCF₂CF₂CF₂—CH₂OCH₂(CH₂)₇CH₂Si(OCH₃)₂OSi(OCH₃)₂(CH₂)₂Si(OCH₃)₂OSi(OCH₃)₂(CH₂)₂—,
—CH₂OCH₂CH₂CH₂Si(OCH₃)₂OSi(OCH₃)₂(CH₂)₃—,
—CH₂OCH₂CH₂CH₂Si(OCH₂CH₃)₂OSi(OCH₂CH₃)₂(CH₂)₃—,
—CH₂OCH₂CH₂CH₂Si(OCH₃)₂OSi(OCH₃)₂(CH₂)₂—,
—CH₂OCH₂CH₂CH₂Si(OCH₂CH₃)₂OSi(OCH₂CH₃)₂(CH₂)₂—,
—(CH₂)₂—,
—(CH₂)₃—,
—(CH₂)₄—,
—(CH₂)₅—,
—(CH₂)₆—,
—(CH₂)₂—Si(CH₃)₂—(CH₂)₂—

### —CONH—(CH₂)—,

—CONH—(CH₂)₂—,
—CONH—(CH₂)₃—,
—CON(CH₃)—(CH₂)₃—,
—CON(Ph)-(CH₂)₃— wherein Ph is a phenyl group,
—CONH—(CH₂)₆—,
—CON(CH₃)—(CH₂)₆—,
—CON(Ph)-(CH₂)₆— wherein Ph is a phenyl group,
—CONH—(CH₂)₂NH(CH₂)₃—,
—CONH—(CH₂)₆NH(CH₂)₃—,
—CH₂O—CONH—(CH₂)₃—,
—CH₂O—CONH—(CH₂)₆—,
—S—(CH₂)₃—,
—(CH₂)₂S(CH₂)₃—,
—CONH—(CH₂)₃Si(CH₃)₂OSi(CH₃)₂(CH₂)₂—,
—CONH—(CH₂)₃Si(CH₃)₂OSi(CH₃)₂OSi(CH₃)₂(CH₂)₂—,
—CONH—(CH₂)₃Si(CH₃)₂O(Si(CH₃)₂O)₂Si(CH₃)₂(CH₂)₂—,
—CONH—(CH₂)₃Si(CH₃)₂O(Si(CH₃)₂O)₃Si(CH₃)₂(CH₂)₂—,
—CONH—(CH₂)₃Si(CH₃)₂O(Si(CH₃)₂O)₁OSi(CH₃)₂(CH₂)₂—,
—CONH—(CH₂)₃Si(CH₃)₂O(Si(CH₃)₂O)₂OSi(CH₃)₂(CH₂)₂—
—C(O)O—(CH₂)₃—,
—C(O)O—(CH₂)₆—,
—CH₂—O—(CH₂)₃—Si(CH₃)₂—(CH₂)₂—Si(CH₃)₂—(CH₂)₂—,
—CH₂—O—(CH₂)₃—Si(CH₃)₂—(CH₂)₂—Si(CH₃)₂—CH(CH₃)—,
—CH₂—O—(CH₂)₃—Si(CH₃)₂—(CH₂)₂—Si(CH₃)₂—(CH₂)₃—,
—CH₂—O—(CH₂)₃—Si(CH₃)₂—(CH₂)₂—Si(CH₃)₂—CH(CH₃)—CH₂—,

### —OCH₂—,

—O(CH₂)₃—,

### —OCFHCF₂—,

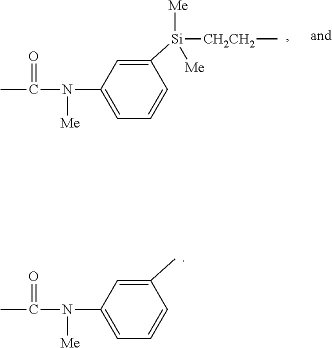

In one embodiment, X⁵, X⁷ and X⁹ are each independently selected from:

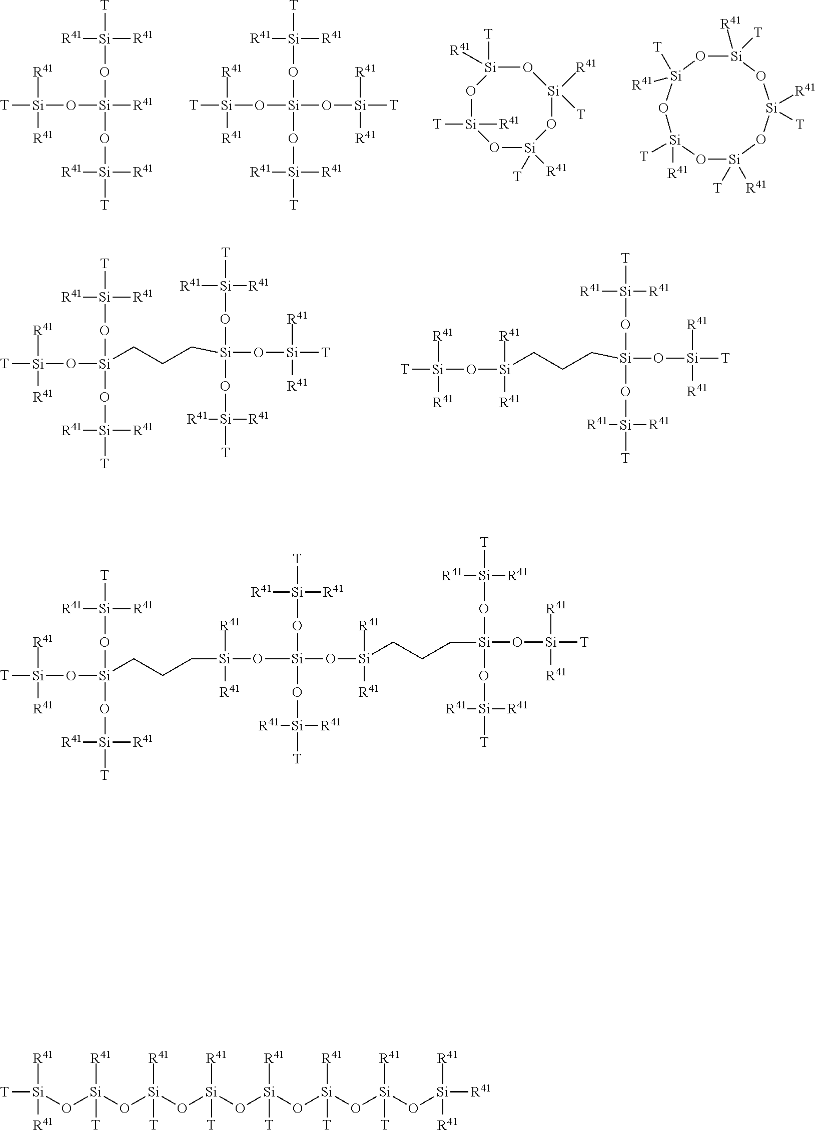

wherein in each group, at least one of T is the following group attached to PFPE in the formulae (A1), (A2), (B1), (B2), (C1), (C2), (D1) and (D2):

—CH₂O(CH₂)₂—,
—CH₂O(CH₂)₃—,
—CF₂O(CH₂)₃—,
—(CH₂)₂—,
—(CH₂)₃—,
—(CH₂)₄—,

### —CONH—(CH₂)—,

—CONH—(CH₂)₂—,
—CONH—(CH₂)₃—,
—CON(CH₃)—(CH₂)₃—,
—CON(Ph)-(CH₂)₃— wherein Ph is phenyl, and

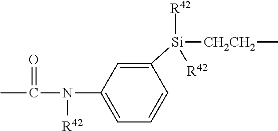

at least one of the other T is —(CH₂)ₙ₁— (wherein n′ is an integer of 2-6) attached to the carbon atom or the Si atom in the formulae (A1), (A2), (B1), (B2), (C1), (C2), (D1) and (D2), and if present, the others T are each independently methyl, phenyl, C1-6-alkoxy, or a radical scavenger group or an ultraviolet ray absorbing group,

R⁴¹ is each independently H, phenyl, C₁₋₆-alkoxy or C₁₋₆-alkyl, and
R⁴² is each independently H, C₁₋₆-alkyl or C₁₋₆-alkoxy.

The number average molecular weight of the perfluoropolyether group containing silane compound of the formulae (A1), (A2), (B1), (B2), (C1), (C2), (D1) and (D2) may be, but not particularly limited to, 5×10²-1×10⁵. The number average molecular weight may be preferably 2,000-30,000, more preferably 3,000-10,000, further preferably 3,000-8,000.

It is noted that, in the present invention, the “number average molecular weight” is measured by GPC (Gel Permeation Chromatography) analysis.

The number average molecular weight of the PFPE portion of the perfluoro(poly)ether group containing silane compound contained in the surface-treating agent of the present invention may be, not particularly limited to, preferably 1,500-30,000, more preferably 2,500-10,000, further preferably 3,000-8,000.

The surface treating composition, in embodiments, the hyrbrid siloxane of formula (1) (and its partially hydrolyzed condensate) in an amount of 10 mass % or less, preferably 5 mass % or less of the total weight of the composition. In other embodiments, the content of said compound represented by the formula (1) and the compound's partially hydrolyzed condensate are 0.01 mass % or more, preferably 0.1 mass % or more of the total composition. In embodiments, the hybrid siloxane of formula (1) is present in the surface treating composition is present in an amount of from about 0.01 mass % to about 10 mass %, from about 0.1 mass % to about 7.5 mass %, from about 0.5 mass % to about 5 mass %, from about 1 mass % to about 2.5 mass %.

The surface treating compositions may optionally comprise one or more additives as desired to provide a particular effect or impart a particular property to the resulting coating. Examples of suitable additives include, but are not limited to, pigments, biocides, processing aids, surfactants, preservatives, flow and levelling agents, microbicides, fungicides, algicides, nematodicites, molluscicides, matting agents, organic polymer particles, thixotropic additives, waxes, flame retardants, anti-stat agent, anti-sag agents, solvents, adhesion promoters, or combinations of two or more thereof.

The surface treating composition can be applied to a surface of a substrate employing any conventional or otherwise known technique such as, but not limited to, spraying, brushing, flow coating, dip-coating, physical vapor deposition, etc. The coating thicknesses of the as-applied (or wet) coating can be selected as desired and can be applied over a generally broad range, such as from about 10 to about 150, from about 20 to about 100, or from about 40 to about 80 microns. Wet coatings of such thicknesses will generally provide (dried) cured coatings having thicknesses ranging from about 1 to 30, from about 2 to about 20, or from about 5 to about 15 microns.

The surface treating composition may be diluted with a solvent. Examples of the solvent include, but are not particularly limited to, for example, a solvent selected from the group consisting of perfluorohexane, CF₃CF₂CHCl₂, CF₃CH₂CF₂CH₃, CF₃CHFCHFC₂F₅, 1,1,1,2,2,3,3,4,4,5,5,6,6-tridecafluorooctane, 1,1,2,2,3,3,4-heptafluorocyclopentane (ZEORORA H (trade name), etc.), C₄F₉OCH₃, C₄F₉OC₂H₅, CF₃CH₂OCF₂CHF₂, C₆F₁₃CH═CH₂, xylene hexafluoride, perfluorobenzene, methyl pentadecafluoroheptyl ketone, trifluoroethanol, pentafluoropropanol, hexafluoroisopropanol, HCF₂CF₂CH₂OH, methyl trifluoromethanesulfonate, trifluoroacetic acid and CF₃O(CF₂CF₂O)ₘ(CF₂O)CF₂CF₃ [wherein m and n are each independently an integer of 0 or more and 1000 or less, the occurrence order of the respective repeating units in parentheses with the subscript m or n is not limited in the formula, with the proviso that the sum of m and n is 1 or more.], 1,1-dichloro-2,3,3,3-tetrafluoro-1-propene, 1,2-dichloro-1,3,3,3-tetrafluoro-1-propene, 1,2-dichloro-3,3,3-trichloro-1-propene, 1,1-dichloro-3,3,3-trichloro-1-propene, 1,1,2-trichloro-3,3,3-trichloro-1-propene, 1,1,1,4,4,4-hexafluoro-2-butene. These solvents may be used alone or as a mixture of 2 or more compound.

The surface-treating agent of the present invention can provide a base material with water-repellency, oil-repellency, antifouling property, waterproof property and high friction durability, and can be suitably used as an antifouling-coating agent or a water-proof coating agent, although the present invention is not particularly limited thereto.

The surface-treating agent of the present invention is impregnated into a porous material, for example, a porous ceramic material, a metal fiber for example that obtained by solidifying a steel wool to obtain a pellet. The pellet can be used, for example, in vacuum deposition.

Next, the article of the present invention will be described.

The article of the present invention comprises a base material and a layer (surface-treating layer) which is formed from the surface-treating agent of the present invention on the surface of the base material.

The surface treating layer obtained by using the surface treating agent of the present invention has high transparency. For example, the haze value may be 0.35% or less, preferably 0.30% or less, more preferably 0.28% or less, further preferably 0.25% or less, further more preferably 0.20% or less. The haze value can be measured by a commercially available haze meter.

Therefore, in the article of the present invention, when the base material is transparent, for example when the article is an optical member, the haze value of the article itself may be 0.35% or less, preferably 0.30% or less, more preferably 0.28% or less, further preferably 0.25% or less, further more preferably 0.20% or less.

The thickness of the surface-treating layer is not specifically limited. For the optical member, the thickness of the surface-treating layer is within the range of 1-50 nm, preferably 1-30 nm, more preferably 1-15 nm, in view of optical performance, surface slip property, friction durability and antifouling property.

The article of the present invention can be produced, for example, as follows.

Firstly, the base material is provided. The base material usable in the present invention may be composed of any suitable material such as a glass, a sapphire glass, a resin (may be a natural or synthetic resin such as a common plastic material, and may be in form of a plate, a film, or others), a metal (may be a simple substance of a metal such as aluminum, copper, or iron, or a complex such as alloy or the like), a ceramic, a semiconductor (silicon, germanium, or the like), a fiber (a fabric, a non-woven fabric, or the like), a fur, a leather, a wood, a pottery, a stone, an architectural member or the like. The base material is preferably a glass or a sapphire glass.

As the glass, a soda-lime glass, an alkali aluminosilicate glass, a borosilicate glass, a non-alkaline glass, a crystal glass, a quartz glass is preferable, a chemically strengthened soda-lime glass, a chemically strengthened alkali aluminosilicate glass, and a chemically strengthened borosilicate glass are more preferable.

As the resin, an acrylic resin or a polycarbonate resin are preferable.

For example, when an article to be produced is an optical member, a material constituting the surface of the base material may be a material for an optical member, for example, a glass or a transparent plastic. For example, when an article to be produced is an optical member, any layer (or film) such as a hard coating layer or an antireflection layer may be formed on the surface (outermost layer) of the base material. As the antireflection layer, either a single antireflection layer or a multi antireflection layer may be used. Examples of an inorganic material usable in the antireflection layer include SiO₂, SiO, ZrO₂, TiO₂, TiO, Ti₂O₃, Ti₂O₅, Al₂O₃, Ta₂O₅, CeO₂, MgO, Y₂O₃, SnO₂, MgF₂, WO₃, and the like. These inorganic materials may be used alone or in combination with two or more (for example, as a mixture). When multi antireflection layer is formed, preferably, SiO₂ and/or SiO are used in the outermost layer. When an article to be produced is an optical glass part for a touch panel, it may have a transparent electrode, for example, a thin layer comprising indium tin oxide (ITO), indium zinc oxide, or the like on a part of the surface of the base material (glass). Furthermore, the base material may have an insulating layer, an adhesive layer, a protecting layer, a decorated frame layer (I-CON), an atomizing layer, a hard coating layer, a polarizing film, a phase difference film, a liquid crystal display module, and the like, depending on its specific specification.

The shape of the base material is not specifically limited. The region of the surface of the base material on which the surface-treating layer should be formed may be at least a part of the surface of the base material, and may be appropriately determined depending on use, the specific specification, and the like of the article to be produced.

The base material may be that of which at least the surface consists of a material originally having a hydroxyl group. Examples of such material include a glass, in addition, a metal on which a natural oxidized film or a thermal oxidized film is formed (in particular, a base metal), a ceramic, a semiconductor, and the like. Alternatively, as in a resin, when the hydroxyl groups are present but not sufficient, or when the hydroxyl group is originally absent, the hydroxyl group can be introduced on the surface of the base material, or the number of the hydroxyl group can be increased by subjecting the base material to any pretreatment. Examples of the pretreatment include a plasma treatment (for example, corona discharge) or an ion beam irradiation. The plasma treatment may be suitably used to introduce the hydroxyl group into or increase it on the surface of the base material, further, to clarify the surface of the base material (remove foreign materials, and the like). Alternatively, other examples of the pretreatment include a method wherein a monolayer of a surface adsorbent having a carbon-carbon unsaturated bond group is formed on the surface of the base material by using a LB method (Langmuir-Blodgett method) or a chemical adsorption method beforehand, and then, cleaving the unsaturated bond under an atmosphere of oxygen and nitrogen.

Alternatively, the base material may be that of which at least the surface consists of a material comprising other reactive group such as a silicon compound having one or more Si—H groups or alkoxysilane.

Next, the film of the above surface-treating agent of the present invention is formed on the surface of the base material, and the film is post-treated, as necessary, and thereby the surface-treating layer is formed from the surface-treating agent.

The formation of the film of the surface-treating agent of the present invention can be performed by applying the above surface-treating agent on the surface of the base material such that the surface-treating agent coats the surface. The method of coating is not specifically limited. For example, a wet coating method or a dry coating method can be used.

Examples of the wet coating method include dip coating, spin coating, flow coating, spray coating, roll coating, gravure coating, and a similar method.

Examples of the dry coating method include deposition (usually, vacuum deposition), sputtering, CVD and a similar method. The specific examples of the deposition method (usually, vacuum deposition) include resistance heating, electron beam, high-frequency heating using microwave, etc., ion beam, and a similar method. The specific examples of the CVD method include plasma-CVD, optical CVD, thermal CVD and a similar method. The deposition method is will be described below in more detail.

Additionally, coating can be performed by an atmospheric pressure plasma method.

When the wet coating method is used, the surface-treating agent of the present invention is diluted with a solvent, and then it is applied to the surface of the base material. In view of stability of the surface-treating agent of the present invention and volatile property of the solvent, the following solvents are preferably used: a C₅₋₁₂ aliphatic perfluorohydrocarbon (for example, perfluorohexane, perfluoromethylcyclohexane and perfluoro-1,3-dimethylcyclohexane); an aromatic polyfluorohydrocarbon (for example, bis(trifluoromethyl)benzene); an aliphatic polyfluorohydrocarbon (for example, C₆F₁₃CH₂CH₃ (for example, ASAHIKLIN (registered trademark) AC-6000 manufactured by Asahi Glass Co., Ltd.), 1,1,2,2,3,3,4-heptafluorocyclopentane (for example, ZEORORA (registered trademark) H manufactured by Nippon Zeon Co., Ltd.); hydrofluorocarbon (HFC) (for example, 1,1,1,3,3-pentafluorobutane (HFC-365mfc)); hydrochlorofluorocarbon (for example, HCFC-225 (ASAHIKLIN (registered trademark) AK225)); a hydrofluoroether (HFE) (for example, an alkyl perfluoroalkyl ether such as perfluoropropyl methyl ether (C₃F₇OCH₃) (for example, Novec (trademark) 7000 manufactured by Sumitomo 3M Ltd.), perfluorobutyl methyl ether (C₄F₉OCH₃) (for example, Novec (trademark) 7100 manufactured by Sumitomo 3M Ltd.), perfluorobutyl ethyl ether (C₄F₉₀C₂H₅) (for example, Novec (trademark) 7200 manufactured by Sumitomo 3M Ltd.), and perfluorohexyl methyl ether (C₂F₅CF(OCH₃)C₃F₇) (for example, Novec (trademark) 7300 manufactured by Sumitomo 3M Ltd.) (the perfluoroalkyl group and the alkyl group may be liner or branched)), or CF₃CH₂OCF₂CHF₂ (for example, ASAHIKLIN (registered trademark) AE-3000 manufactured by Asahi Glass Co., Ltd.), 1,2-dichloro-1,3,3,3-tetrafluoro-1-propene (for example, VERTREL (registered trademark) Sion manufactured by Du Pont-Mitsui Fluorochemicals Co., Ltd.) and the like. These solvents may be used alone or as a mixture of 2 or more compound. Among them, the hydrofluoroether is preferable, perfluorobutyl methyl ether (C₄F₉OCH₃) and/or perfluorobutyl ethyl ether (C₄F₉OC₂H₅) are particularly preferable. Furthermore, the solvent can be mixed with another solvent, for example, to adjust solubility of the perfluoro(poly)ether group containing silane compound.

When the dry coating method is used, the surface-treating agent of the present invention may be directly subjected to the dry coating method, or may be diluted with a solvent, and then subjected to the dry coating method.

The formation of the film is preferably performed so that the surface-treating agent of the present invention is present together with a catalyst for hydrolysis and dehydration-condensation in the coating. Simply, when the wet coating method is used, after the surface-treating agent of the present invention is diluted with a solvent, and just prior to applying it to the surface of the base material, the catalyst may be added to the diluted solution of the surface-treating agent of the present invention. When the dry coating method is used, the surface-treating agent of the present invention to which a catalyst has been added is used itself in deposition (usually, vacuum deposition), or pellets may be used in the deposition (usually, the vacuum deposition), wherein the pellets is obtained by impregnating a porous metal such as iron or copper with the surface-treating agent of the present invention to which the catalyst has been added.

As the catalyst, any suitable acid or base can be used. As the acid catalyst, for example, acetic acid, formic acid, trifluoroacetic acid, or the like can be used. As the base catalyst, for example, ammonia, an organic amine, or the like can be used.

Next, the film is post-treated as necessary. This post-treatment is, but not limited to, a treatment in which water supplying and dry heating are sequentially performed, in more particular, may be performed as follows.

After the film of the surface-treating agent of the present invention is formed on the surface of the base material as mentioned above, water is supplied to this film (hereinafter, referred to as precursor coating). The method of supplying water may be, for example, a method using dew condensation due to the temperature difference between the precursor coating (and the base material) and ambient atmosphere or spraying of water vapor (steam), but not specifically limited thereto.

It is considered that, when water is supplied to the precursor coating, water acts on a hydrolyzable group bonding to Si present in the perfluoro(poly)ether group containing silane compound in the surface-treating agent of the present invention, thereby enabling rapid hydrolysis of the compound.

The supplying of water may be performed under an atmosphere, for example, at a temperature of 0-250° C., preferably 60° C. or more, more preferably 100° C. or more and preferably 180° C. or less, more preferably 150° C. By supplying water at such temperature range, hydrolysis can proceed. The pressure at this time is not specifically limited but simply may be ambient pressure.

Then, the precursor coating is heated on the surface of the base material under a dry atmosphere over 60° C. The method of dry heating may be to place the precursor coating together with the base material in an atmosphere at a temperature over 60° C., preferably over 100° C., and for example, of 250° C. or less, preferably of 180° C. or less, and at unsaturated water vapor pressure, but not specifically limited thereto. The pressure at this time is not specifically limited but simply may be ambient pressure.

Under such atmosphere, between the PFPE containing silane compound of the present inventions, the groups bonding to Si after hydrolysis are rapidly dehydration-condensed with each other. Furthermore, between the compound and the base material, the group bonding to Si in the compound after hydrolysis and a reactive group present on the surface of the base material are rapidly reacted, and when the reactive group present on the surface of the base material is a hydroxyl group, dehydration-condensation is caused. As the result, the bond between the perfluoro(poly)ether group containing silane compound and the base material is formed.

The above supplying of water and dry heating may be sequentially performed by using a superheated water vapor.

As mentioned above, the post-treatment can be performed. It is noted that though the post-treatment may be performed in order to further increase friction durability, it is not essential in the producing of the article of the present invention. For example, after applying the surface-treating agent to the surface of the base material, it may be enough to only stand the base material.

As described above, the surface-treating layer derived from the film of the surface-treating agent of the present invention is formed on the surface of the base material to produce the article of the present invention. The surface-treating layer thus formed has higher transparency, high surface slip property and high friction durability. Furthermore, this surface-treating layer may have water-repellency, oil-repellency, antifouling property (for example, preventing from adhering a fouling such as fingerprints), waterproof property (preventing the ingress of water into an electrical member, and the like), surface slip property (or lubricity, for example, wiping property of a fouling such as fingerprints and excellent tactile feeling in a finger) depending on a composition of the surface-treating agent used, in addition to high friction durability, thus may be suitably used as a functional thin film.

The article having the surface-treating layer obtained according to the present invention is not specifically limited to, but may be an optical member. Examples of the optical member include the followings: displays such as a cathode ray tube (CRT; for example, TV, personal computer monitor), a liquid crystal display, a plasma display, an organic EL display, an inorganic thin-film EL dot matrix display, a rear projection display, a vacuum fluorescent display (VFD), a field emission display (FED; Field Emission Display), or a front surface protective plate, an antireflection plate, a polarizing plate, or an anti-glare plate of these display, or these whose surface is subjected to antireflection treatment; lens of glasses, or the like; a touch panel sheet of an instrument such as a mobile phone or a personal digital assistance; a disk surface of an optical disk such as a Blu-ray disk, a DVD disk, a CD-R or MO; an optical fiber, and the like; a display surface of a clock.

Other article having the surface-treating layer obtained according to the present invention may be also a ceramic product, a painted surface, a cloth product, a leather product, a medical product and a plaster.

The article having the surface-treating layer obtained according to the present invention may be also a medical equipment or a medical material.

Hereinbefore, the article produced by using the surface-treating agent of the present invention is described in detail. It is noted that an application, a method for using or a method for producing the article are not limited to the above exemplification.

The coatings can impart a variety of properties to the surface to which they are applied including, but not limited to, hydrophobicity, oleophobicity, scratch resistance, anticorrosive properties, antifouling, antibacterial, antithrombic properties, anti-graffiti, drag-reduction, anti-icing, etc.

### EXAMPLES

Reference will now be made to the following Examples. The Examples are for the purpose of illustrating aspects and embodiments of the invention. They are not intended to be limiting examples of embodiments, features, or characteristics of the invention.

In Examples, compositions for a surface-treating agent were prepared, and substrates with a surface-treating agent were fabricated using the obtained compositions for forming a surface-treating layer, and they were evaluated. Components blended in the compositions for a compound are as follows.

### Synthesizing Example of Compound 1 (R^{f} Silane Oligomer Synthesis Methods)

### Example 1-1: Synthesis of Hybrid Oligomer of Fluorosilane-Epoxy Silane (Compound 1-1)

Synthesis of hybrid oligomer fluorosilane-epoxy silane was performed by taking trimethoxy(3,3,4,4,5,5,6,6,7,7,8,8,8-tridecafluorooctyl)silane (10.0 g, 0.0213 mol), 3-glycidyloxypropyl) trimethoxysilane (1.68 g, 0.0071 mol), and 2, 2, 2 trifluoroethanol (3.0 g, 0.029 mol) as solvent in a round-bottomed flask and stirring for 30 minutes. To this reaction mixture, 400 μL of 5000 ppm trifluoroacetic acid as catalyst was charged, and stirring continued for 4 hours at 40° C. After that, the reaction mass was cooled to room temperature and quenched with 300 μL of 5000 ppm sodium bicarbonate solution. Further, the reaction mixture was dried with anhydrous sodium sulphate powder, and the solvent was evaporated using rotary evaporator under reduced pressure to obtain the colorless viscous liquid. The product was stored in a controlled temperature of 7-10° C.

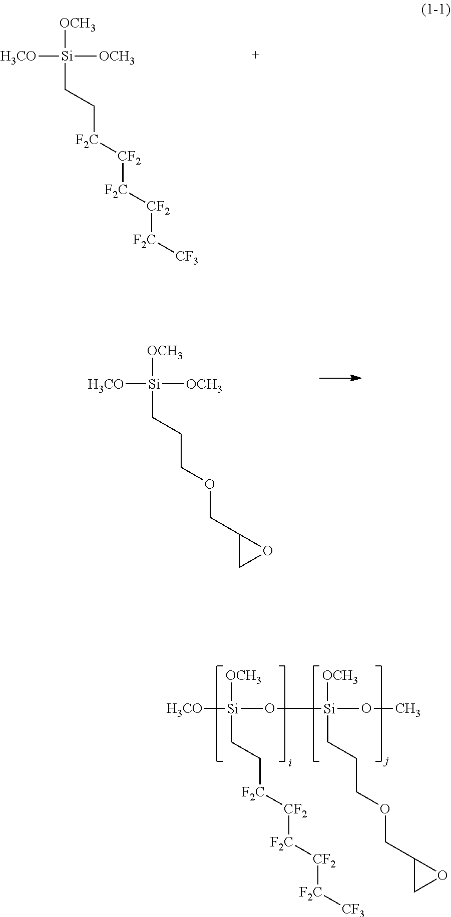

| Molar Ratio | Si NMR | Solid | | | |
|---|---|---|---|---|---|
| (Fluoro:Epoxy) | (T⁰, T¹, T², T³) | Content (%) | Mn | Mw | Mw/Mn |
| 3:1 | 14:61:24:0 | 72 | 2100 | 4700 | 2.2 |

### Example 1-2: Synthesis of Hybrid Oligomer of Fluoro Silane and Aminosilane (Compound 1-2)

Synthesis of hybrid oligomer fluorosilane-aminosilane was carried out by taking 3:2 molar ratio of trimethoxy(3,3,4,4,5,5,6,6,7,7,8,8,8-tridecafluorooctyl)silane (15 g, 0.0320 mol), N-(beta-aminoethyl)-gamma-aminopropyltrimethoxysilane (4.73 g, 0.0213 mol) and 2, 2, 2 trifluoroethanol (3 g, 0.029 mol) into a round-bottomed flask and stirring for 30 min. To this reaction mixture, 400 μL of 0.05 N ammonia solution was added as catalyst and the stirring was continued at room temperature for 4 h. The reaction was quenched by removing the water content using anhydrous sodium sulphate and volatiles were removed under reduced pressure. The oligomer was isolated as a clear viscous liquid and stored in controlled temperature of 7-10° C.

### Synthesizing Example 2 of Compound 2

Compound 2-1: As the compound 2-1 represented by following chemical formula was used.

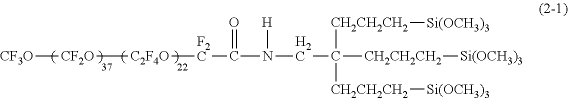

Compound 2-2: As the compound 2-2 represented by following chemical formula was used.

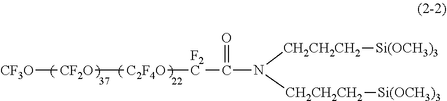

Preparation of Composition for Surface-Treating Agent

The composition for forming a surface-treating agent to be used for fabricating the substrates with surface-treating layer of examples were prepared as follows.

Preparing Composition

The compound 1 and compound 2 were mixed at the mass ratios shown in Table 1, with the total amount with respect to 100% by mass of the solvent which is hydrofluoroether (Novec HFE7200 manufactured by Sumitomo 3M Ltd.) being 20% by mass. First, the compound 2 and HFE7200 added in the order mentioned to a vessel and stirred at 25° C. for 30 min. Then, Compound 1 was added in the order mentioned and stirred at 25° C. for 30 min, whereby the composition for forming each composition was obtained.

### Examples 1 to 5 and Comparative Examples 1 to 2

Surface-treating agent prepared in the above manner was vacuum deposited on a chemical strengthening glass (Gorilla glass manufactured by Corning Incorporated; thickness:0.7 mm). Processing condition of the vacuum deposition was a pressure of 3.0×10⁻³ Pa. Firstly, silicon dioxide was deposited on the surface of this chemical strengthening glass in a manner of an Argon sputtering. Subsequently, the surface-treating agent of 180 mg (that is, it contained of 36 mg of composition) was vacuum-deposited on one plate of the chemical strengthening glass having the deposited layer which stood under a temperature of 20° C. and a humidity of 65% for 24 hours,

TABLE 1

| | | | Comparative Examples | |
|---|---|---|---|---|
| | | | 1 | 2 |
| Compund 1 | hybrid oligomer of fluorosilane- | (Compound 1-1) | | |
| | epoxy silane | | | |
| | hybrid oligomer of fluoro | (Compound 1-2) | | |
| | silane and aminosilane | | | |
| Compund 2 | (Compound 2-1) | | 100 | |
| | (Compound 2-2) | | | 100 |
| Water | Number of rubbing (times) | 0 | 114 | 113 |
| contact | | 3,000 | 109 | 113 |
| angle | | 6,000 | 106 | 112 |
| (degree) | | 9,000 | 96 | 107 |
| | | 12,000 | | 100 |
| | | 15,000 | | |

| | | |
|---|---|---|
| Durability (times) | 6,000 | 12,000 |

| | | | Examples | | | | |
|---|---|---|---|---|---|---|---|
| 1 | | | 1 | 2 | 3 | 4 | 5 |
| Compund 1 | hybrid oligomer of fluorosilane- | (Compound 1-1) | 1 | | | | |
| | epoxy silane | | | | | | |
| | hybrid oligomer of fluoro | (Compound 1-2) | | 0.02 | 0.1 | 0.5 | 0.5 |
| | silane and aminosilane | | | | | | |
| Compund 2 | (Compound 2-1) | | 100 | 100 | 100 | 100 | |
| | (Compound 2-2) | | | | | | 100 |
| Water | Number of rubbing (times) | 0 | 114 | 114 | 114 | 114 | 113 |
| contact | | 3,000 | 108 | 110 | 112 | 109 | 111 |
| angle | | 6,000 | 106 | 108 | 110 | 107 | 110 |
| (degree) | | 9,000 | 105 | 106 | 107 | 105 | 110 |
| | | 12,000 | 104 | 103 | 95 | 103 | 109 |
| | | 15,000 | 102 | 94 | | 101 | 106 |

| | | | | | |
|---|---|---|---|---|---|
| Durability (times) | >15000 | 12,000 | 9,000 | >15000 | >15000 |

Evaluation of Friction Durability

A static water contact angle of the surface-treating layers formed on the surface of the base material in the above Examples and Comparative Examples respectively was measured. The static water contact angle was measured for 2 L of water by using a contact angle measuring instrument (manufactured by KYOWA INTERFACE SCIENCE Co., Ltd.).

Firstly, as an initial evaluation, the static water contact angle of the surface-treating layer of which the surface had not still contacted with anything after formation thereof was measured (the number of rubbing is zero). Then, as an evaluation of the friction durability, eraser friction durability evaluation was performed. Specifically, the based material on which the surface-treating layer was formed was horizontally arranged, and then, an eraser (rubber, dia. 6 mm) was contacted with the exposed surface of the surface-treating layer and a load of 1000 gf was applied thereon. Then, the eraser was shuffled at a rate of 40 rpm while applying the load. The static water contact angle (degree) was measured per 3000 shuttling. The durability was evaluated when the measured value of the contact angle became less than 100 degrees. The results are shown in Table 1.

As understood from the above results, it was confirmed that Examples using the compositions of perfluoropolyether group containing silane compound and oligomeric composition of fluoroalkyl group containing silane compound shows improved friction durability in comparison with Comparative Examples using the compounds having no such oligomeric compositions.

What has been described above includes examples of the present specification. It is, of course, not possible to describe every conceivable combination of components or methodologies for purposes of describing the present specification, but one of ordinary skill in the art may recognize that many further combinations and permutations of the present specification are possible. Accordingly, the present specification is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

The foregoing description identifies various, non-limiting embodiments of a hybrid siloxane oligomer, compositions thereof, coatings formed from such compositions, and articles comprising such coatings. Modifications may occur to those skilled in the art and to those who may make and use the invention. The disclosed embodiments are merely for illustrative purposes and not intended to limit the scope of the invention or the subject matter set forth in the claims.

1. A composition, which comprises
(i) a compound, and/or the compound's partially hydrolyzed condensate, represented by the formula (1): 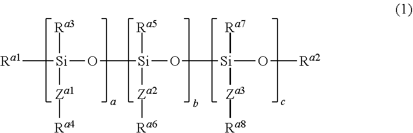
where R^{a1}, R^{a3}, R^{a5}, and R^{a7} are each independently selected from an alkoxy, an alkoxycarbonyl, a halide, an alkyl, an aralkyl, or an aromatic group, with the proviso that at least one of R^{a1}, R^{a3}, R^{a5}, and/or R^{a7} is an alkoxy, an alkoxycarbonyl, or a halide group;
R^{a2} is selected from hydrogen, an alkyl, an aralkyl, or an aromatic group;
R^{a4} is represented by the formula CzHyFx where z is 1-20 and x+y is 2z+1 where x is 1 or greater.
R^{a6} and R^{as} are each independently selected from an alkoxy, an alkoxycarbonyl, a halide, an alkyl, an aralkyl, an aromatic group, an epoxy, an amine;
Z^{a1}, Z^{a2}, and Z^{a3} are each independently selected from an organic linking group having 1-20 carbon atoms optionally containing heteroatoms, with the proviso that when R^{a6} or R^{a8} is an alkoxy, an alkoxycarbonyl, or a halide, then Z^{a2} or Z^{a3}, respectively, cannot be O, N, or S;
a, b, and c are each independently 0 to about 100, a+b+c is greater than 0, a is greater than 0, and b+c is greater than 0; and
(ii) a pefluoro(poly)ether group containing silane of Formula (2) and/or Formula (3):
[A]_{b1}Q²[B]_{b2} Formula (2)
[B]_{b2}Q²[A]Q²[B]_{b2} Formula (3)
where, Q² is a linking group having a valency of (b1+b2),
A is a group represented by R^{f2}—O—R^{f2}— or —R^{f3}—O—R^{f2}—, where R^{f2} is a poly(oxyfluoroalkylene) chain, and R^{f3} is a perfluoroalkyl group or perfluoroalkylene group,
B is a monovalent group having one —R¹²—(SiR²ᵣ—X²₃₋ᵣ), where R¹² is a organic group preferably hydrocarbon group having 2 to 10 carbon atoms that optionally has an ether oxygen atom between the carbon-carbon atoms or at an end opposite to a side bonded with Si or optionally has —NH— between the carbon-carbon atoms, R² are each independently a hydrogen atom or a monovalent hydrocarbon group having 1 to 6 carbon atoms, the hydrocarbon group optionally containing a substituent, X² are each independently a hydroxyl group or a hydrolyzable group, and r is an integer of 0 to 2, and including no fluorine atom,
Q² and B include no cyclic siloxane structure,
b1 is an integer of 1 to 3,
b2 is an integer of 1 to 9, and
in a case where b1 is 2 or more, b1 pieces of A may be identical or different, and
b2 pieces of B may be identical or different.

2. The composition according to claim 1, wherein R² in Formula (2) and/or Formula (3) is a group represented by —(CₐF₂ₙO)ₙ—, where a is an integer of 1 to 6, n is an integer of 2 or more, and the —CₐF₂ₐO— units may be identical or different.

3. The composition according to claim 1, wherein R^{f2} in Formula (2) and/or Formula (3) is a group represented by a group —(CF₂CF₂CF₂CF₂CF₂CF₂O)ₙ₁—(CF₂CF₂CF₂CF₂CF₂O)ₙ₂—(CF₂CF₂CF₂CF₂O)ₙ₃—(CF₂CF₂CF₂O)ₙ₄—(CF(CF₃)CF₂O)ₙ₅—(CF₂CF₂O)ₙ₆—(CF₂O)ₙ₇—, where n1, n2, n3, n4, n5, n6, and n7 are each independently an integer of 0 or more, the sum of n1, n2, n3, n4, n5, n6, and n7 is 2 or more, and the repeating units may exist in block, alternately, or randomly.

4. The composition according to claim 1, wherein R in Formula (1) is a group represented by a group —C₆F₁₃.

5. The composition according to claim 1, wherein the number average molecular weight of said compound by the formula (1) and the compound's partially hydrolyzed condensate are preferably at least 300, more preferably at least 500, more preferably at least 1000.

6. The composition according to claim 1, wherein the number average molecular weight of said compound by the formula (1) and the compound's partially hydrolyzed condensate are preferably at most 10000, more preferably at most 5000, more preferably at most 3000.

7. The composition according to claim 1, wherein the content of said compound represented by the formula (1) and the compound's partially hydrolyzed condensate are 10 mass % or less, preferably 5 mass % or less of the total weight of the composition.

8. The composition according to claim 1, wherein the content of said compound represented by the formula (1) and the compound's partially hydrolyzed condensate are 0.01 mass % or more, preferably 0.1 mass % or more of the total composition.

9. The composition according to claim 1, wherein formula 2 is at least the compound selected from the group consisting of (A1), (A2), (B1), (B2), (C1), (C2), (D1) and (D2): 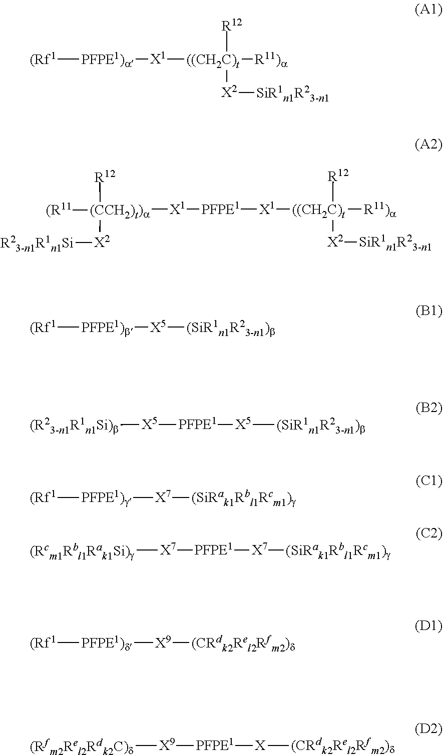
wherein,
PFPE is each independently at each occurrence a group of the formula:
—(OC₄F₈)a-(OC₃F₆)b-(OC₂F₄)c-(OCF₂)d-
wherein a, b, c and d are each independently an integer of 0-200 with (a+b+c+d)≥1, and the order of the repeating units in parentheses with the subscripts a-d is not limited;
R^{f} is each independently at each occurrence C1-16-alkyl optionally substituted by F;
R¹ is each independently at each occurrence OH or a hydrolyzable group;
R² is each independently at each occurrence H or C1-22-alkyl;
R¹¹ is each independently at each occurrence H or halogen;
R12 is each independently at each occurrence H or lower alkyl;
n1 is, independently per a unit (—SiR¹ₙ₁R²₃₋ₙ₁), an integer of 0-3;
at least one n1 is an integer of 1-3 in the formulae (A1), (A2), (B1) and (B2);
X¹ is each independently a single bond or a 2-10 valent organic group;
X² is each independently at each occurrence a single bond or a divalent organic group;
t is each independently at each occurrence an integer of 1-10;
α is each independently an integer of 1-9;
α′ is each independently an integer of 1-9;
X⁵ is each independently a single bond or a 2-10 valent organic group;
β is each independently an integer of 1-9;
β′ is each independently an integer of 1-9;
X⁷ is each independently a single bond or a 2-10 valent organic group;
γ is each independently an integer of 1-9;
γ′ is each independently an integer of 1-9;
R^{a} is each independently at each occurrence —Z¹—SiR⁷¹ₚ₁R⁷²_{q1}R⁷³ᵣ₁;
Z¹ is each independently at each occurrence O or a divalent organic group;
R⁷¹ is each independently at each occurrence R^{a′} having the same definition as R^{a};
R72 is each independently at each occurrence OH or a hydrolyzable group;
R73 is each independently at each occurrence H or lower alkyl;
p1 is each independently at each occurrence an integer of 0-3;
q1 is each independently at each occurrence an integer of 0-3;
r1 is each independently at each occurrence an integer of 0-3;
at least one q1 is an integer of 1-3 in the formula (C1) and (C2);
and in R^{a} the number of Si atoms which are straightly linked via the Z¹ group is ≤5;
R^{b} is each independently at each occurrence OH or a hydrolyzable group;
R^{c} is each independently at each occurrence H or lower alkyl;
k1 is each independently at each occurrence an integer of 1-3;
l1 is each independently at each occurrence an integer of 0-2;
m1 is each independently at each occurrence an integer of 0-2;
and (k1+l1+m1)=3 in each unit in parentheses with the subscript γ;
X⁹ is each independently a single bond or a 2-10 valent organic group;
δ is each independently an integer of 1-9;
δ′ is each independently an integer of 1-9;
R^{d} is each independently at each occurrence —Z²—CR⁸¹ₚ₂R⁹²_{q2}R⁸³ᵣ₂;
Z² is each independently at each occurrence O or a divalent organic group;
R⁸¹ is each independently at each occurrence Rd′;
R^{d′} has the same definition as that of R^{d};
in Rd, the number of C atoms which are straightly linked via the Z² group is ≤5;
R⁸² is each independently at each occurrence —Y—SiR⁸⁵ⁿ²R⁸⁶₃₋ₙ₂;
Y is each independently at each occurrence a divalent organic group;
R⁸⁵ is each independently at each occurrence OH or a hydrolyzable group;
R⁸⁶ is each independently at each occurrence H or lower alkyl;
n2 is an integer of 1-3 independently per unit (—Y—SiR⁸⁵ₙ₂R⁸⁶₃₋ₙ₂);
in formulae (D1) and (D2), at least one n2 is an integer of 1-3;
R⁸³ is each independently at each occurrence H or a lower alkyl group;
p2 is each independently at each occurrence an integer of 0-3;
q2 is each independently at each occurrence an integer of 0-3;
r2 is each independently at each occurrence an integer of 0-3;
R^{e} is each independently at each occurrence —Y—SiR⁸⁵ₙ₂R⁸⁶ₙ₂;
Rf is each independently at each occurrence H or lower alkyl;
k2 is each independently at each occurrence an integer of 0-3;
l2 is each independently at each occurrence an integer of 0-3; and
m2 is each independently at each occurrence an integer of 0-3;
in formulae (D1) and (D2), at least one q2 is 2 or 3, or at least one l2 is 2 or 3

10. The composition according to claim 1, wherein Rf is a perfluoroalkyl group having 1-16 carbon atoms.

11. The composition according to claim 1, wherein PFPE is a group of any of the following formulas (i) to (iv):
—(OCF₂CF₂CF₂)_{b1} (i)
wherein b1 is an integer of 1-200;
—(OCF(CF₃)CF₂)_{b1}— (ii)
wherein b1 is an integer of 1-200;
—(OCF₂CF₂CF₂CF₂)ₐ₁—(OCF₂CF₂CF₂)_{b1}—(OCF₂CF₂)_{c1}—(OCF₂)_{d1}— (iii)
wherein a1 and b1 are each independently 0 or an integer of 1-30, c1 and d1 are each independently an integer of 1-200, and the occurrence order of the respective repeating units in parentheses with the subscript a1, b1, c1 or d1 is not limited in the formula;
or
—(R⁷—R⁸)_{f}— (iv)
wherein R⁷ is OCF₂ or OC₂F₄,
R⁸ is a group selected from OC₂F₄, OC₃F₆ and OC₄F₈; and
f is an integer of 2-100.

12. The composition according to claim 1, wherein X5, X7 and X9 are each independently a 2 valent organic group β, γ and δ are 1, and β′, γ′ and δ′ are 1.

13. The composition according to claim 1, wherein X5, X7 and X9 are each independently a 2 valent organic group, β, γ and δ are 1, and β′, γ′ and δ′ are 1.

14. The composition according to claim 1, wherein X⁵, X⁷ and X⁹ are each independently —(R³¹)_{p′}—(X^{a})_{q′}—
wherein:
R³¹ is each independently a single bond, —(CH₂)_{s′}—, wherein s′ is an integer of 1-20, or a o-, m- or p-phenylene group;
X^{a} is —(X^{b})_{l′}— wherein
l′ is an integer of 1-10;
X^{b} is each independently at each occurrence selected from —O—, —S—, o-, m- or p-phenylene, —C(O)O—, —Si(R³³)₂—, —(Si(R³³)₂O)_{m′}—Si(R³³)₂— (wherein m′ is an integer of 1-100), —CONR³⁴—, —O—CONR³⁴—, —NR³⁴— and —(CH₂)_{n′}— (wherein n′ is an integer of 1-20);
R³³ is each independently at each occurrence phenyl, C₁₋₆-alkyl or C₁₋₆-alkoxy;
R³⁴ is each independently at each occurrence H, phenyl or C₁₋₆-alkyl;
R³¹ and X^{a} is may be substituted with one or more substituents selected from F, C₁₋₃-alkyl and C₁₋₃-fluoroalkyl.
p′ is 0, 1 or 2;
q′ is 0 or 1;
and at least one of p′ and q′ is 1,
and the order of the repeating units in parentheses with the subscript p′ or q′ is not limited.

15. The composition according to claim 1, wherein X⁵, X⁷ and X⁹ are each independently selected from:
—CH₂O(CH₂)₂—,
—CH₂O(CH₂)₃—,
—CH₂O(CH₂)₆—,
—CH₂O(CH₂)₃Si(CH₃)₂OSi(CH₃)₂(CH₂)₂—,
—CH₂O(CH₂)₃Si(CH₃)₂OSi(CH₃)₂OSi(CH₃)₂(CH₂)₂—,
—CH₂O(CH₂)₃Si(CH₃)₂O(Si(CH₃)₂O)₂Si(CH₃)₂(CH₂)₂—,
—CH₂O(CH₂)₃Si(CH₃)₂O(Si(CH₃)₂O)₃Si(CH₃)₂(CH₂)₂—,
—CH₂O(CH₂)₃Si(CH₃)₂O(Si(CH₃)₂O)₁₀Si(CH₃)₂(CH₂)₂—,
—CH₂O(CH₂)₃Si(CH₃)₂O(Si(CH₃)₂O)₂₀Si(CH₃)₂(CH₂)₂—,
—CH₂OCF₂CHFOCF₂—,
—CH₂OCF₂CHFOCF₂CF₂—,
—CH₂OCF₂CHFOCF₂CF₂CF₂—,
—CH₂OCH₂CF₂CF₂OCF₂—,
—CH₂OCH₂CF₂CF₂OCF₂CF₂—,
—CH₂OCH₂CF₂CF₂OCF₂CF₂CF₂—,
—CH₂OCH₂CF₂CF₂OCF(CF₃)CF₂OCF₂—,
—CH₂OCH₂CF₂CF₂OCF(CF₃)CF₂OCF₂CF₂—,
—CH₂OCH₂CF₂CF₂OCF(CF₃)CF₂OCF₂CF₂CF₂—,
—CH₂OCH₂CHFCF₂OCF₂—,
—CH₂OCH₂CHFCF₂OCF₂CF₂—,
—CH₂OCH₂CHFCF₂OCF₂CF₂CF₂—,
—CH₂OCH₂CHFCF₂OCF(CF₃)CF₂OCF₂—,
—CH₂OCH₂CHFCF₂OCF(CF₃)CF₂OCF₂CF₂—,
—CH₂OCH₂CHFCF₂OCF(CF₃)CF₂OCF₂CF₂CF₂—
—CH₂OCH₂(CH₂)₇CH₂Si(OCH₃)₂OSi(OCH₃)₂(CH₂)₂Si(OCH₃)₂OSi(OCH₃)₂(CH₂)₂—,
—CH₂OCH₂CH₂CH₂Si(OCH₃)₂OSi(OCH₃)₂(CH₂)₃—,
—CH₂OCH₂CH₂CH₂Si(OCH₂CH₃)₂OSi(OCH₂CH₃)₂(CH₂)₃—,
—CH₂OCH₂CH₂CH₂Si(OCH₃)₂OSi(OCH₃)₂(CH₂)₂—,
—CH₂OCH₂CH₂CH₂Si(OCH₂CH₃)₂OSi(OCH₂CH₃)₂(CH₂)₂—,
—(CH₂)₂—,
—(CH₂)₃—,
—(CH₂)₄—,
—(CH₂)₅—,
—(CH₂)₆—,
—(CH)—(CH₂),
—(CH₂)₂—Si(CH₃)₂—(CH₂)₂—
—CONH—(CH₂)—,
—CONH—(CH₂)₂—,
—CONH—(CH₂)₃—,
—CON(CH₃)—(CH₂)₃—,
—CON(Ph)-(CH₂)₃— wherein Ph is a phenyl group,
—CONH—(CH₂)₆—,
—CON(CH₃)—(CH₂)₆—,
—CON(Ph)-(CH₂)₆— wherein Ph is a phenyl group,
—CONH—(CH₂)₂NH(CH₂)₃—,
—CONH—(CH₂)₆NH(CH₂)₃—,
—CH₂O—CONH—(CH₂)₃—,
—CH₂O—CONH—(CH₂)₆—,
—S—(CH₂)₃—,
—(CH₂)₂S(CH₂)₃—,
—CONH—(CH₂)₃Si(CH₃)₂OSi(CH₃)₂(CH₂)₂—,
—CONH—(CH₂)₃Si(CH₃)₂OSi(CH₃)₂OSi(CH₃)₂(CH₂)₂—,
—CONH—(CH₂)₃Si(CH₃)₂O(Si(CH₃)₂O)₂Si(CH₃)₂(CH₂)₂—,
—CONH—(CH₂)₃Si(CH₃)₂O(Si(CH₃)₂O)₃Si(CH₃)₂(CH₂)₂—,
—CONH—(CH₂)₃Si(CH₃)₂O(Si(CH₃)₂O)₁₀Si(CH₃)₂(CH₂)₂—,
—CONH—(CH₂)₃Si(CH₃)₂O(Si(CH₃)₂O)₂₀Si(CH₃)₂(CH₂)₂—
C(O)O—(CH₂)₃—,
—C(O)O—(CH₂)₆—,
—CH₂—O—(CH₂)₃—Si(CH₃)₂—(CH₂)₂—Si(CH₃)₂—(CH₂)₂—,
—CH₂—O—(CH₂)₃—Si(CH₃)₂—(CH₂)₂—Si(CH₃)₂—CH(CH₃)—,
—CH₂—O—(CH₂)₃—Si(CH₃)₂—(CH₂)₂—Si(CH₃)₂—(CH₂)₃—,
—CH₂—O—(CH₂)₃—Si(CH₃)₂—(CH₂)₂—Si(CH₃)₂—CH(CH₃)—CH₂—,
—OCH₂—,
—O(CH₂)₃—,
—OCFHCF₂—,

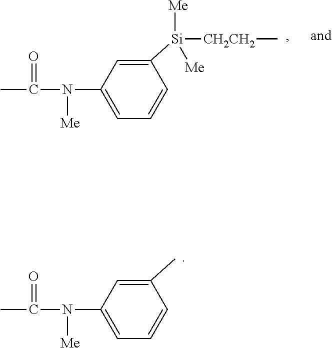

16. The composition according to claim 1, wherein k1 is 3, and q1 is 3 in R^{a}.

17. The composition according to claim 1, wherein l2 is 3, and n2 is 3.

18. The composition according to claim 1, wherein Y is C₁₋₆-alkylene, —(CH₂)_{g′}—O—(CH₂)_{h′}— (wherein g′ is an integer of 0-6, and h′ is an integer of 0-6), or -phenylene-(CH₂)_{i′}— (wherein i′ is an integer of 0-6).

19. The composition according to claim 1, wherein X⁵, X⁷ and X⁹ are each independently a 3-10 valent organic group.

20. The composition according to claim 1, wherein X⁵, X⁷ and X⁹ are each independently selected from: 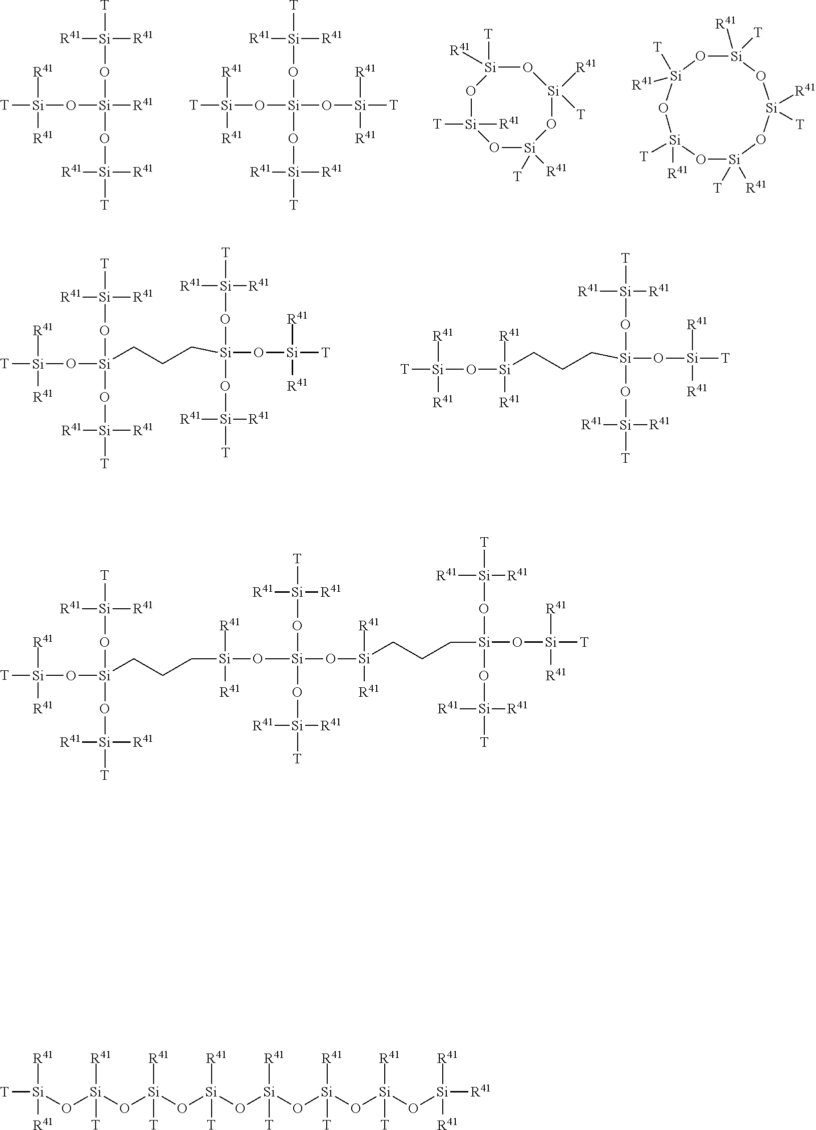
wherein in each group, at least one of T is the following group attached to PFPE in the formulae (A1), (A2), (B1), (B2), (C1), (C2), (D1) and (D2):
—CH₂O(CH₂)₂—,
—CH₂O(CH₂)₃—,
—CF₂O(CH₂)₃—,
—(CH₂)₂—,
—(CH₂)₃—,
—(CH₂)₄—,
—CONH—(CH₂)—,
—CONH—(CH₂)₂—,
—CONH—(CH₂)₃—,
—CON(CH₃)—(CH₂)₃—,
—CON(Ph)-(CH₂)₃— wherein Ph is phenyl, and 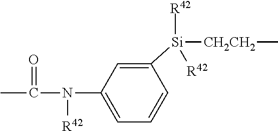
at least one of the other T is —(CH₂)ₙ— (wherein n is an integer of 2-6) attached to the carbon atom or the Si atom in the formulae (A1), (A2), (B1), (B2), (C1), (C2), (D1) and (D2), and if present, the others T are each independently methyl, phenyl, C₁₋₆-alkoxy, or a radical scavenger group or an ultraviolet ray absorbing group,
R⁴¹ is each independently H, phenyl, C₁₋₆-alkoxy or C₁₋₆-alkyl, and
R⁴² is each independently H, C₁₋₆-alkyl or C₁₋₆-alkoxy.

21. An article comprising a base material and a surface treating layer disposed on a surface of the base material, wherein the surface treating layer is formed from a composition of claim 1.

22. The article of claim 21, wherein the base material is selected from a glass, a sapphire glass, a resin, a metal, a ceramic, a semiconductor, a fiber, a fur, a leather, a wood, a pottery, or a stone.

23. A method of forming an article comprising applying a composition of claim 1 to a surface of a base material to form a coating layer.

24. The method of claim 23 comprising treating the coating layer with water subsequent to the formation of the coating layer.

25. The method of claim 24 comprising heating the coating under a dry atmosphere.

26. The method of claim 25, wherein treating the coating layer with water and heating the coating is performed by exposing the coating to superheated water vapor.
